(19) United States
(12) Patent Application Publication
(10) Pub. No.: US 2020/0388068 A1
(43) Pub. Date: Dec. 10, 2020

(54) SYSTEM AND APPARATUS FOR USER CONTROLLED VIRTUAL CAMERA FOR VOLUMETRIC VIDEO

(71) Applicants: FAI YEUNG, Palo Alto, CA (US); KIMBERLY LOZA, San Francisco, CA (US); HARLEEN GILL, Los Altos, CA (US); RITESH KALE, Cupertino, CA (US); MARCUS REED, San Bruno, CA (US); ERIC FOLEY, Vallejo, CA (US); ATHARVA PURANIK, San Jose, CA (US); RISHIT BHATIA, Santa Clara, CA (US)

(72) Inventors: FAI YEUNG, Palo Alto, CA (US); KIMBERLY LOZA, San Francisco, CA (US); HARLEEN GILL, Los Altos, CA (US); RITESH KALE, Cupertino, CA (US); MARCUS REED, San Bruno, CA (US); ERIC FOLEY, Vallejo, CA (US); ATHARVA PURANIK, San Jose, CA (US); RISHIT BHATIA, Santa Clara, CA (US)

(21) Appl. No.: 16/897,136

(22) Filed: Jun. 9, 2020

Related U.S. Application Data
(60) Provisional application No. 62/859,645, filed on Jun. 10, 2019.

(51) Int. Cl. G06T 15/08; G06T 7/73; G06N 20/00; H04N 13/178; H04N 13/161; H04R 3/00

(52) U.S. Cl. CPC G06T 15/08; G06T 7/73; G06N 20/00; G06T 2207/10028; H04N 13/161; H04R 3/005; H04N 13/178

(57) ABSTRACT

Apparatus, system, and method for rendering an immersive virtual reality environment of an event. For example, one embodiment of a system comprises: a video decoder to decode video data captured from a plurality of different cameras at an event to generate decoded video, the decoded video comprising a plurality of video images captured from each of the plurality of different cameras; image image recognition hardware logic to performing image recognition on at least a portion of the video to identify objects within the plurality of video images; a metadata generator to associate metadata with one or more of the objects; a point cloud data generator to generate point cloud data based on the decoded video, the point cloud data usable to render an immersive virtual reality (VR) environment for the event; and a network interface to transmit the point cloud data or VR data derived from the point cloud data to a client device.

### CROSS REFERENCE TO RELATED APPLICATIONS

This application claims the benefit of co-pending U.S. Provisional Patent Application Ser. No. 62/859,645, filed Jun. 10, 2019, all of which is herein incorporated by reference.

### BACKGROUND

### Field of the Invention

This disclosure pertains to videography, image capture, and playback. More particularly, this disclosure relates to systems and methods for user controlled virtual camera for volumetric video.

### Description of the Related Art

Techniques are known for using video of a sporting event captured from multiple cameras and using the video to generate a virtual reality (VR) environment. However, these previous solutions are limited to a static view of the event, where the perspective within the VR environment is pre-selected. The way that a user is able to control and view the sports events in those previous solutions is extremely limited and non-interactive.

### BRIEF DESCRIPTION OF THE DRAWINGS

FIG. 1 is a schematic diagram showing unique embodiments of time code synchronization mechanisms that could be used to synchronize frames being captured by capture stations from a plurality of panoramic camera heads before being processed and distributed.

FIG. 2 is a schematic diagram showing how multiple receivers, or receiving modules on a viewer machine would receive time-stamped frames from the panoramic video feeds, and to show the user interface as the intermediate application for managing how the user input requests are handled and how the clients are manipulated to cater to the user request.

FIG. 3 is a schematic diagram showing how multiple panoramic video feeds can be received at a client by a receiver and user interface that also has controller functionality built in.

FIG. 4 is a flow chart showing the steps involved in a viewer machine to receive multiple panoramic video streams, to buffer the frames from each feed, and to determine the frame from the buffer to be displayed to the end user based on the camera in view and the time stamp sought by the user.

FIG. 5 is a flow chart showing the steps involved in handling a Camera Changed Event triggered by the user.

FIG. 6 is a flow chart showing the steps involved in handling a Video Playback State Changed Event triggered by the user.

FIG. 7 is a flow chart showing the steps involved in handling a Viewport Changed Event triggered by the user.

FIGS. 8-A and 8-B are two parts of a flowchart showing how the Transport Control Events are handled by the system and how the time stamp for the frame to be displayed to the user is determined based on the Video Playback State of the viewer application.

FIG. 9 shows how multiple panoramic cameras are strategically placed an event location and how they are connected to the capture stations, processing stations, and distribution channel.

FIG. 10 illustrates one embodiment of an architecture for capturing and streaming real time video of an event;

FIG. 11 illustrates one embodiment which performs stitching using rectification followed by cylindrical projection;

FIGS. 12A-D illustrate video processing techniques employed in one embodiment of the invention;

FIG. 13 illustrates a front view of a subset of the operations performed to generate a panoramic virtual reality video stream;

FIG. 14 illustrates a method in accordance with one embodiment of the invention;

FIG. 15 illustrates one embodiment which performs stitching operations using Belief Propagation;

FIG. 16 illustrates a stitching architecture which uses stitching parameters from one or more prior frames to stitch a current frame;

FIG. 17 illustrates one embodiment which performs coordinate transformations to reduce bandwidth and/or storage;

FIG. 18 illustrates a method in accordance with one embodiment of the invention;

FIG. 19 illustrates an architecture for performing viewing transformations on virtual reality video streams to adjust;

FIG. 20 illustrates one embodiment in which key and fill signals are used for inserting content into a captured video stream;

FIG. 21 illustrates a comparison between a microservices architecture and other architectures;

FIGS. 22-23 illustrate different views from within an immersive virtual reality generated with point clouds;

FIGS. 24A-B illustrate embodiments of a system for capturing audio/video data of an event, generating point cloud data and related metadata for an immersive virtual reality (VR) experience of the event;

FIGS. 25-33 illustrate additional features of one embodiment of the immersive VR environment; and

FIG. 34 illustrates a method in accordance with one embodiment of the invention.

### DETAILED DESCRIPTION

This disclosure is submitted in furtherance of the constitutional purposes of the U.S. Patent Laws “to promote the progress of science and useful arts” (Article 1, Section 8).

Embodiments of the present invention disclose an apparatus and method for receiving a video stream from a plurality of Panoramic Video Camera Heads or from a local storage disk, storing the video data in a local memory buffer, and viewing regions of interest within any one of the panoramic videos using user interface devices, while controlling the video time, playback speed, and playback direction globally across all panoramic video data in a synchronous manner. According to one construction, multiple Panoramic Video Camera Heads and are synchronized through a time code generator that triggers the image capture across all camera heads synchronously. According to another construction, multiple camera heads are synchronized by one “Master” camera head that sends trigger signals to all the camera heads. Further, according to yet another construction, each camera head is set to “free-run” with a pre-defined frame rate, and the processing computers all capture the latest frame from each of these cameras and timestamp them with a time code from a time code generator.

Various embodiments herein are described with reference to the figures. However, certain embodiments may be practiced without one or more of these specific details, or in combination with other known methods and configurations. In the following description, numerous specific details are set forth, such as specific configurations and methods, etc., in order to provide a thorough understanding of the present disclosure. In other instances, well-known construction techniques and methods have not been described in particular detail in order to not unnecessarily obscure the present disclosure. Reference throughout this specification to “one embodiment” or “an embodiment” means that a particular feature, configuration, composition, or characteristic described in connection with the embodiment is included in at least one embodiment. Thus, the appearances of the phrase “in one embodiment” or “an embodiment” in various places throughout this specification are not necessarily referring to the same embodiment. Furthermore, the particular features, configurations, compositions, or characteristics may be combined in any suitable manner in one or more embodiments.

As used herein, the term “Transport Control” is understood to mean a user interface that allows a viewer to control the video playback, such as choosing between play, pause, rewind and forward, and the speed of rewind or forward.

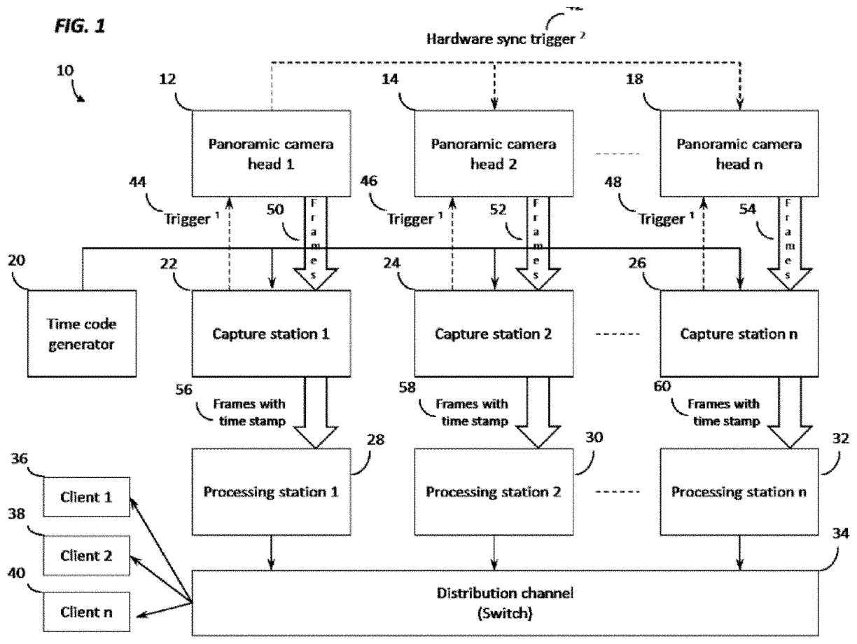

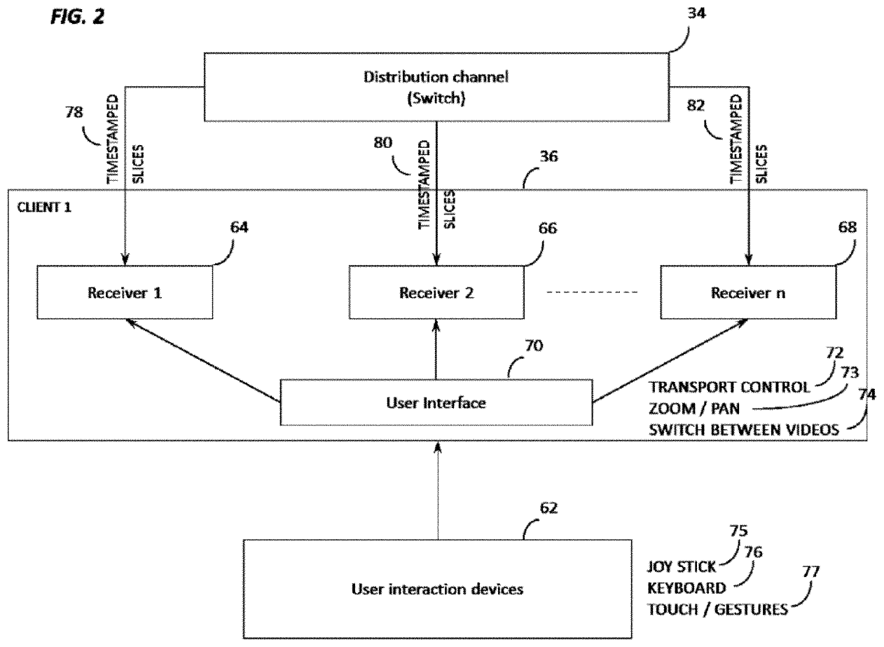

FIG. 1 shows construction of the time code synchronization mechanism 10 extending across a plurality of panoramic camera heads 12, 14 and 18 and capture stations 22, 24 and 25. A time code generator 20 is used to get a consistent time stamp based on the desired rate that frames 50, 52 and 54 need to be captured from the panoramic cameras 12, 14 and 18. The same time code from time code generator 20 is received by each of the Capture Stations 22, 24 and 26, and in one of the embodiments of this mechanism, the time code is used to trigger.sup.1 44, 46 and 48 the panoramic cameras 12, 14 and 18. This is also referred to as a “software trigger” 44, 46 and 48 of the panoramic cameras 12, 14 and 18. The panoramic cameras 12, 14 and 18 capture a frame 50, 52 and 54 when triggered by trigger 44, 46 and 48, respectively, and return the frame 50, 52 and 54 to the corresponding Capture Stations 22, 24 and 26 that generated the trigger 44, 46 and 48. The Capture Stations 22, 24 and 26 attach the time-stamp information from the time code to the frames, forming “frames with time stamps” 56, 58 and 60. Because the time-code is shared between Capture Stations 22, 24 and 26, the frames 56. 58 and 60 generated from each of the Capture Stations 22, 24 and 26 for a given time-code are synchronized, as they have the same time-stamp. These frames 56, 58 and 60 are then transmitted to the Processing Station 28, 30 and 32, respectively, where they are compressed for transmission over the network and sent to some Distribution Channel 34. The time-stamp information on the frames 56, 58 and 60 is maintained throughout this processing, compression, and distribution process. The distribution device, or channel (switch) 34 is configured to distribute the processed images or compressed video stream to client processors in clients 36, 38 and 40. Clients 36, 38 and 40 also include memory.

Another embodiment of the time code synchronization mechanism 10 of FIG. 1 involves triggering the panoramic camera heads 12, 14 and 18 using a “hardware sync trigger.sup.2” 42. The hardware trigger 42 is generated at specific time intervals based on the desired frame rate. This rate of hardware triggering has to match the rate of time codes being generated by the time code generator 20. One of the panoramic camera heads 12, 14 and 18 acts as a “Master” and all other panoramic camera heads 12, 14 and 18 act as “Slaves”. The “Master” panoramic camera triggers itself and all the “Slave” panoramic cameras synchronously. When a trigger is generated, a frame is captured at the panoramic camera 50, 52 or 54. Once the frame 50, 52 or 54 is captured, an event is invoked at the Capture Station 22, 24 or 26, and this is when the Capture Station 22, 24 or 26 “grabs” the frame from the camera 12, 14 or 18, and associates the time stamp corresponding to the latest time-code received from the time-code generator 20 to the frame 50, 52 or 54.

A third embodiment of the time code synchronization mechanism 10 of FIG. 1 involves letting the panoramic cameras 12, 14 and 18 capture frames in a “free run” mode, where each of the panoramic cameras 12, 14 and 18 trigger as fast as possible. The Capture Station 22, 24 and 26 uses the time code signal to “grab” the latest frame 50, 52 or 54 that was captured by the panoramic camera 12, 14 or 18, and associates the time stamp corresponding to the time-code with the frame.

FIG. 2 shows multiple receivers 64, 66 and 68 on a client machine 36 receiving time-stamped slices 78, 80 and 82, respectively, from the panoramic video feeds via distribution channel 34. A user interface 70 on the client machine 36 determines which receiver is the active receiver 64, 66 or 68 displayed to the user. User interface 70 also manages the user interaction input from devices 62 like a joystick 75, a keyboard 76, and a touch or gesture based device(s) 77. User interface 70 uses this input to determine which client stream should be the active stream (switch between videos 74), and what section of the panoramic video should be displayed (zoom/tilt/pan 73) to the end-user. Another input from the user-interaction devices is the input related to transport control 72. User interface 70 uses this input and passes it on to all the receivers. This enables all the receivers to perform the same transport control operations to their respective panoramic video streams, and ensures that all the panoramic video streams are synchronized.

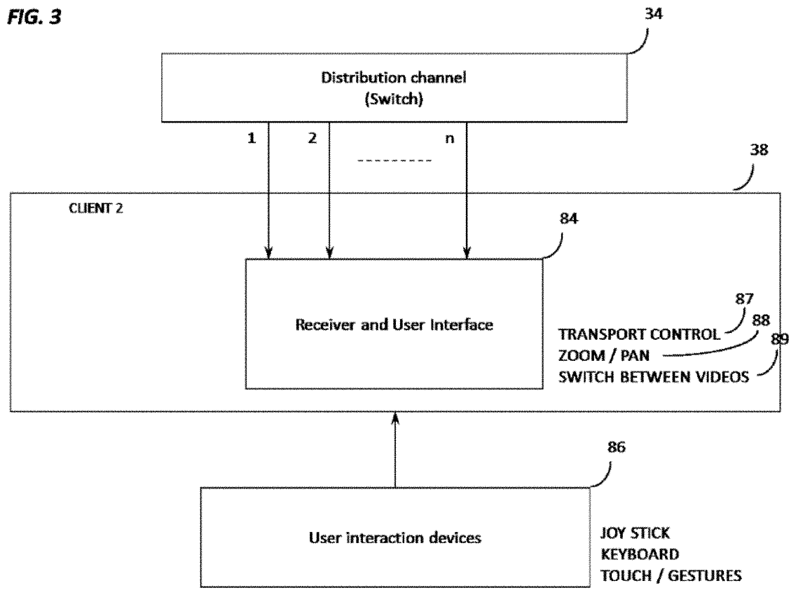

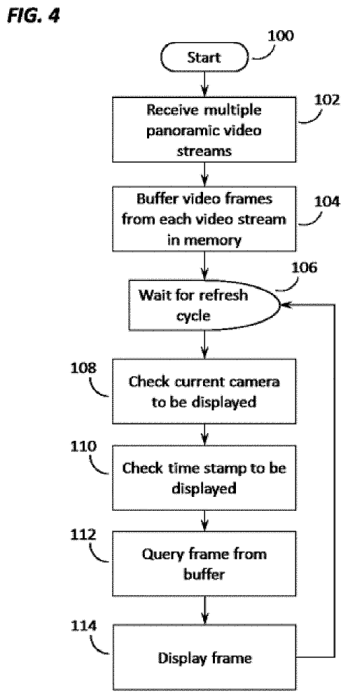

FIG. 3 shows another embodiment of the client application on the viewer machine. In this embodiment, a single application serves as the receiver and user interface 84. The receiver receives time-stamped frames for all the panoramic video streams via distribution channel 34 and manages each of these streams in its own application memory. The receiver also includes processing circuitry. User interface functionality described in FIG. 2 is also integrated in this application. As described in FIG. 2, the user interface manages the input from the user interaction devices 86 and performs the actions for switching between videos 89, what section of the panoramic video should be displayed (zoom/pan/tilt 88) to the end-user, and how to apply the transport control 87 to all the streams in memory.

The following variables are stored with the controller module for receiver and user interface 84 that determine the state of the view that is displayed to the end-user: a. Current Camera to be displayed b. Current Time Stamp of the frame to be displayed c. Current Video Playback State—Possible values are Play, Pause, Fast Forward, Rewind, Live d. Current Viewport—The viewport is determined by the current zoom, pan, and tilt values

The user interaction devices 86 could generate the following types of events that are handled by the receiver and user interface 84: a. Camera Changed Event b. Video Playback State Changed Event c. Viewport Changed Event d. Transport Control Event

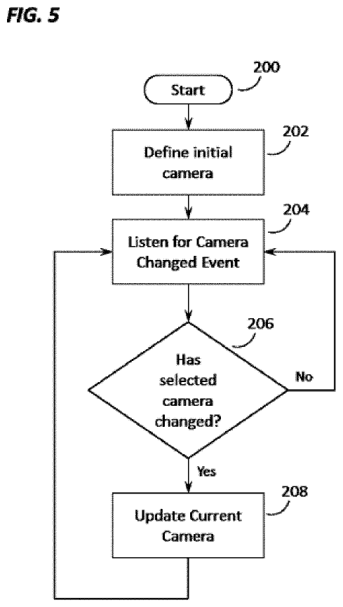

FIG. 4 shows the steps involved in a viewer machine to receive multiple panoramic video streams and determine the frame to be displayed to the end user. The frames from each panoramic video stream that is received by the viewer machine 102 are buffered in memory (Hard disk drive, application memory, or any other form of storage device) 104. Each frame received by the viewer machine has a time-stamp associated with it, which serves as the key to synchronize frames across multiple panoramic streams. Once the frames have started buffering, the viewer application enters a refresh cycle loop starting with a “wait for refresh cycle” 106. The refresh cycle is a periodic set of operations performed by the application at every refresh interval of the display. The viewing application stores the information about the panoramic camera being displayed 108 and the information about the time stamp to be displayed based on the playback state of the application and user inputs related to transport controls. For each refresh cycle, the application checks the current panoramic camera that needs to be displayed, and then checks for the time stamp to be displayed 110. Using these two pieces of information, the appropriate frame to be displayed is sought from the buffer in memory 112. This frame is then passed on to the application for display 114 in that refresh cycle.

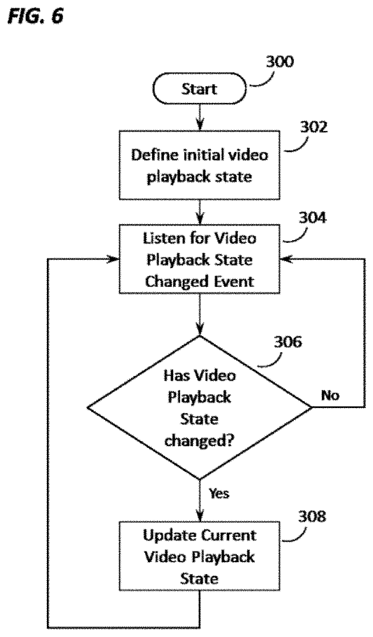

FIG. 5 shows the steps involved in handling the Camera Changed Event triggered by the user. An initial camera is used, or defined 202 as the default after initiating a start 200. Then the application goes into a ‘ listen’ mode 204 where it is waiting for Camera Changed Events 206 triggered by the user interaction devices. When a request for changing the selected camera is received, the local variable in the application that stores current camera information is updated 208, and the application goes back into the ‘listen’ mode, waiting for the next Camera Changed Event.

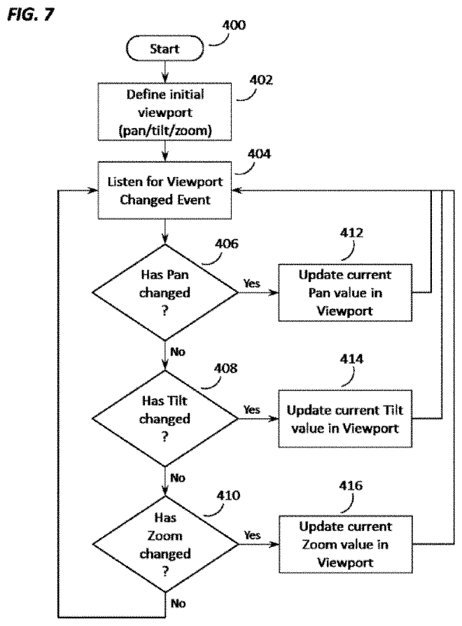

FIG. 6 shows the steps involved in handling the Video Playback State Changed Event triggered by the user from start 300. An initial video playback state 302 is used as the default to start with. Then the application goes into a ‘ listen’ mode 304 where it is waiting for Video Playback State Changed Events 306 triggered by the user interaction devices. When a request for changing the video playback state is received, the local variable in the application that stores the current video playback state is updated 308, and the application goes back in the ‘ listen’ mode, waiting for the next Video Playback State Changed event.

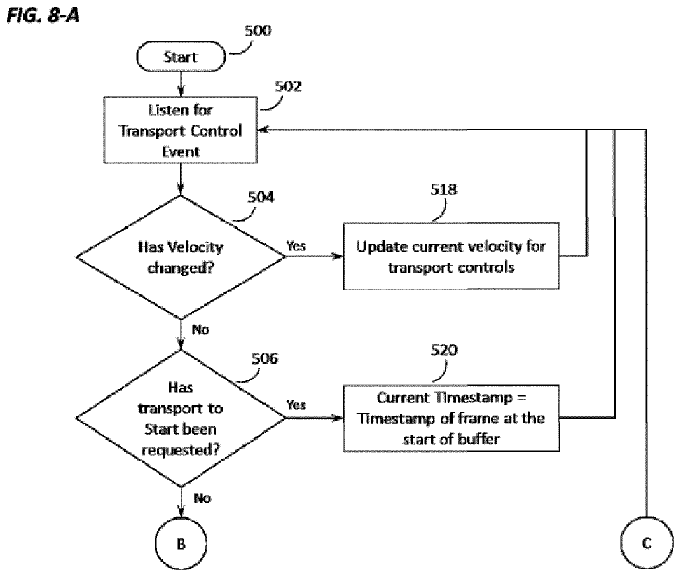

FIG. 7 shows the steps involved in handling the Viewport Changed Event triggered by the user from start 400. The viewport could be changed by changing the zoom, tilt, or pan. An initial zoom, tilt, and pan is used as a default 402 to start with. Then the application goes into a ‘ listen’ mode 404 where it is waiting for Viewport Changed Events triggered by the user interaction devices. When a request for changing the viewport is received, the application checks to see if the zoom 410, pan 406, or tilt 408 value has been changes, and updates the local variables 416, 412 and 414, respectively in the application that store the zoom, pan, and tilt. The application then goes back in the ‘ listen’ mode, waiting for the next Viewport Changed Event.

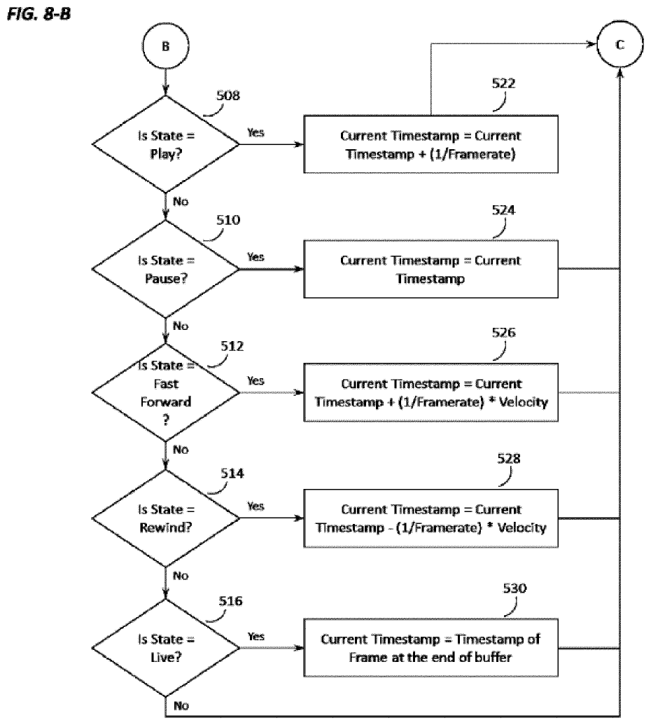

FIGS. 8-A and 8-B show how the Transport Control Events are handled by the viewing application initiated at start 500. The application is listening for Transport Control Changed Events 502. The application checks to see if the velocity of transport control was changed 504. If the velocity was changed, the value of the velocity stored within the application is updated 518 and the application goes back to listening for Transport Control Changed Events. If velocity has not changed, then the application checks to see if the user has requested to “Transport to Start” 506 so that they view the start of the buffered video stream in memory. If “Transport to Start” was requested, the value of the current timestamp to display is changed to be the same as the timestamp of the frame at the start of the buffer in memory 520, and the application goes back to listening for Transport Control Changed Events. If “Transport to Start” was not requested, then the application determines the current timestamp to be used for display based on playback state that the application is in. If the application is in “Play” state 508, then the current timestamp is incremented to the next timestamp 522. If the application is in the “Pause” state 520, then the current timestamp is not changed 524. If the application is in the “Fast Forward” 512 or “Rewind” state 514, then the current timestamp is incremented 526 or decremented 528 taking the frame rate and velocity of transport into account. If the application is in the “Live” state 516, then the current timestamp is set to the timestamp of the frame at the end of buffered frames in memory 530.

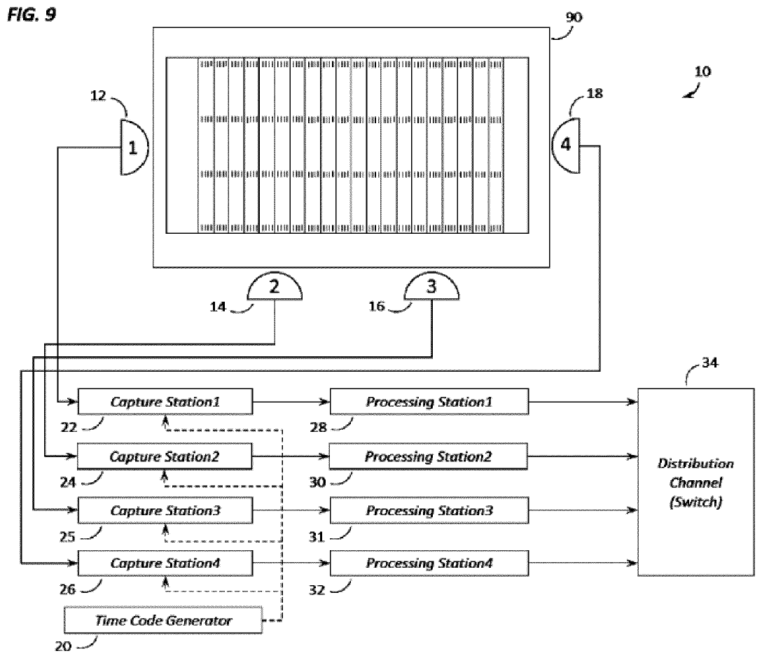

FIG. 9 shows a football field 90 as the event location where multiple panoramic cameras 12, 14, 16 and 18 are located at strategic locations such that they provide different angles to view a sporting event from and allow one or more end-users to choose the angle that is best suited (for them) for viewing the event at any given point in time. Each of the panoramic video cameras 12, 14,16 and 18 is connected to a capture station 22, 24, 25 and 26, respectively. Each capture station 22, 24, 25 and 26 receives a time-code from a time-code generator, and the time-stamp from the time-code is attached to the frames received from the panoramic video camera. The frames are then transmitted to the processing stations 28, 30, 31 and 32 where they are processed and streamed out to the distribution channel 34. Distribution channel 34 receives the frames and communicates the frames over a network to multiple clients that are connected to the distribution channel.

A panoramic video capture device as used herein comprises multiple sensors placed in a circular array such that a portion of image captured by each sensor overlaps with a portion of image captured by adjacent sensors. The overlapping images from the different sensors are captured synchronously based on a trigger mechanism, and these overlapping images form the basis for creation of a single, seamless panoramic image.

As used herein, a processor is a high-performance server-grade machine housing multiple graphic processing units (GPUs). A GPU is capable of performing large number of operations in parallel. The use of multiple GPUs in the processor allows for highly parallelized computations on multiple image frames being communicated by the panoramic video capture device. Memory can also be resident.

A processor comprises the following modules. First, a capture module is responsible for triggering the panoramic video capture device and retrieving the image frames once the exposure of the frame is complete. In certain embodiments of the capture module, the triggering of the sensors is not performed by this module. There is a separate trigger mechanism for the sensors and the capture module is notified of the event every time a new image frame is available on the panoramic video capture device. When this notification is received by the capture module, it retrieves the image frame from the panoramic video capture device.

As used herein, a processing module is operative to receive the raw frame from the capture module and applies the following filters to the raw frame: Demosaicing filter: In this filter, a full color image is reconstructed using the incomplete color samples from the raw image frames. Coloring filter: The full color image output from the demosaicing filter is then converted to appropriate color space (for example, RGB) for use in downstream modules. Seam blending filter: Colored images output from the coloring filter are used for blending the seam using stitching algorithms on the overlap between adjacent images.

As used herein a splicing module is responsible for using the images output from the processing module, and putting them together with the ends lined up against each other in such that the aggregate of these individual images creates one panoramic image.

Also as used herein, a slicing module takes the seam blended panoramic image, and splits this image into multiple slices. This is done so that each slice of the panoramic image can be distributed over the network in an optimized fashion. This overcomes the existing limitations of certain network protocols that cannot communicate panoramic images above a certain size of the image.

As used herein, a time stamp module listens for the time code from the time code generator. This time stamp is then attached to each slice of the image sections output from the slicing module.

As used herein, a compression module takes the image frame output by the time stamp module and compresses it using certain image compression techniques (JPEG, H.264, etc.) for transmission of over the network.

As used herein, a distribution device is a kind of router or switch that is used for transmitting the compressed frames over the network. Multiple clients could connect to the distribution device and receive the image frames being transmitted. In addition to this, subsequent distribution devices themselves could be connected to a distribution device transmitting the images for relaying the images over a wide network.

As used herein a client process processes the combination of sub-processes and modules on a viewer's machine to receiving image frames from a distribution device, store them in buffer, manage the user input from the user interaction devices, and display the video images to the end-user.

The client process is broken down into the following modules:

A receiving module which connects to the source of the video images via the distribution device, receives the images over the network, and stores them in a buffer on the viewer's machine.

A user interface module is used for managing the user input from the user interaction devices. In one of the implementations of the user interface module, the joystick controller is used for capturing the user input. The user input could be provided using buttons on the joystick or using the multiple thumb pad controls on the joystick. Different buttons are used to track the video playback state change input for play, pause, fast forward, rewind, or live mode A thumb pad control is used to track the viewport change inputs for zoom, pan, tilt of the view Another thumb pad control is used to track the transport control input for jogging forward or back based on the velocity of jog determined by how far the thumb pad control has been pushed.

A display module is used for displaying portion of the panoramic video frames to the user. The portion of the video frame to be displayed is determined based on the inputs from the user interface module. Image frame from the buffer is fetched and based on the other user inputs, the portion of the panoramic image to be displayed is determined. This portion is then displayed to the end-user for viewing.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

### Panoramic Broadcast Virtual Reality (VR) Architecture

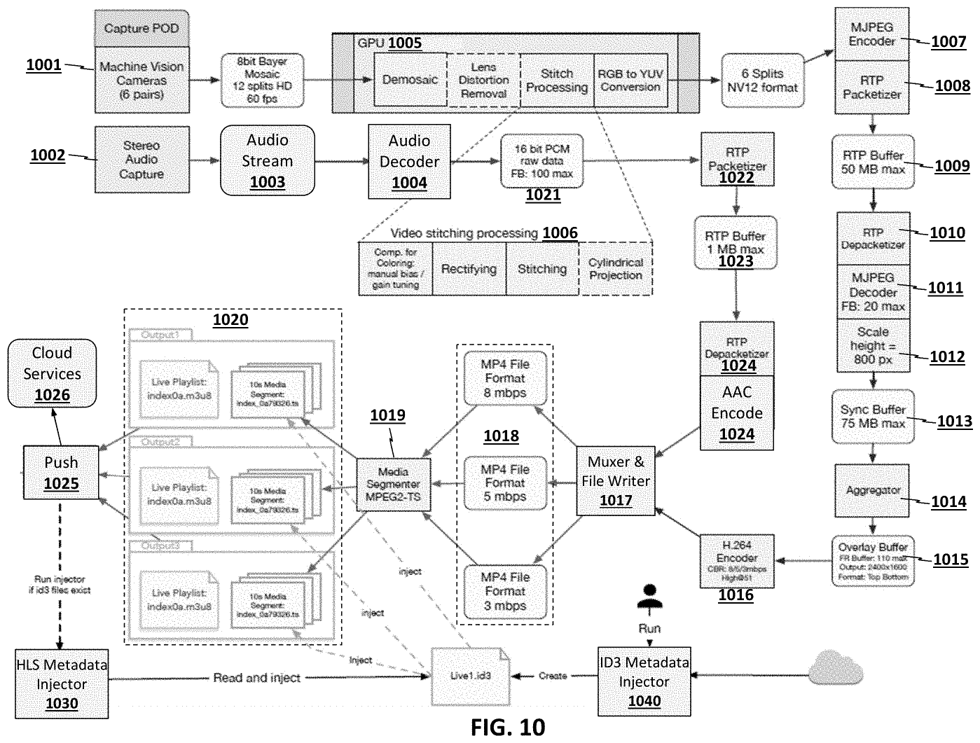

FIG. 10 illustrates one example of a panoramic broadcast virtual reality (VR) system. As mentioned, in one embodiment, a plurality of stereoscopic cameras 1001 capture video of an event from different perspectives (e.g., a sporting event, musical performance, theatrical performance, etc) and stereo audio capture unit 1002 simultaneously captures and encodes audio 1003 of the event. In one implementation, the six pairs of stereoscopic cameras are integrated on a video capture device 1001 (referred to herein as a capture POD) and any number of such video capture devices 1001 are distributed at different event locations to capture video from different perspectives. As used herein, a stereoscopic camera is typically implemented as two cameras: one to reproduce a left eye perspective and one to reproduce a right eye perspective. As discussed below, however, in certain embodiments (e.g., such as when bandwidth reduction is required) only the left (right) eye video may be captured and the right (left) stream may be reproduced by performing a transformation on the left (right) video stream (i.e., using the coordinate relationship between the left and right eyes of a user as well as the coordinates of the event).

While certain embodiments described herein use six stereoscopic cameras in each device POD, any number of pairs of stereoscopic cameras may be used while still complying with the underlying principles of the invention (e.g., 10 pairs/POD, 12 pairs/POD, etc).

In one embodiment, regardless of how the cameras 1001 are configured, the video stream produced by each capture POD comprises an 8-bit Bayer mosaic at with 12 splits (i.e., 12 different image streams from the 6 pairs of cameras). One or more graphics processing units (GPUs) 1005 then process the video stream in real time as described herein to produce a panoramic VR stream. In the illustrated embodiment, the GPU 1005 performs various image processing functions including, but not limited to, de-mosaic operations, cropping to remove redundant portions of adjacent video streams, lens distortion reduction, color adjustments, and image rotations.

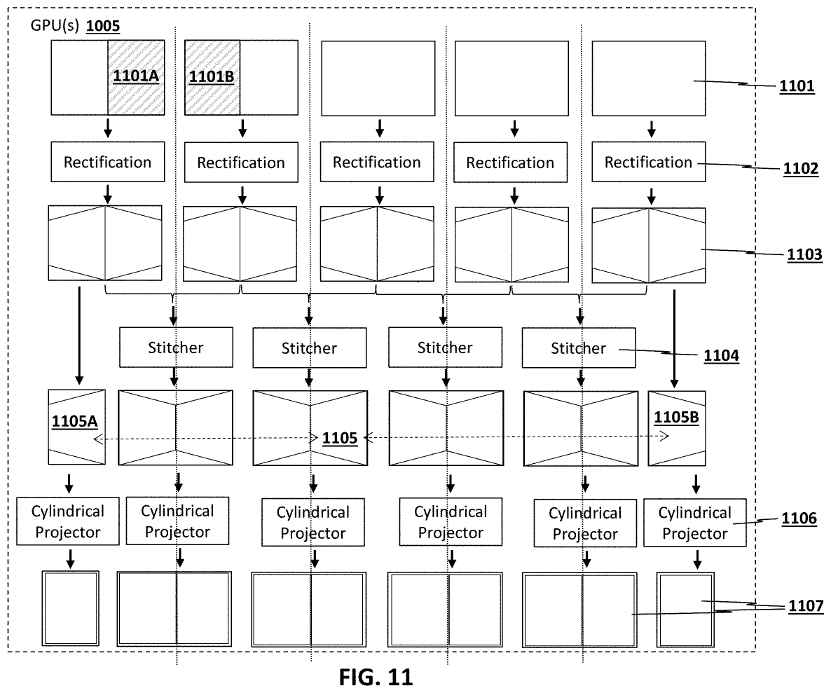

Following image processing, the GPU 1005 performs stitch processing 1006 on adjacent image frames to form a stitched panoramic image. One example of the stitch processing 1006 illustrated in FIG. 11 includes rectification operations 1102, stitching operations 1104, and cylindrical projection operations 1106. In particular, FIG. 11 illustrates a specific implementation of stitching using 5 image streams to generate the panoramic image stream. It is assumed that the 5 illustrated streams are processed for one eye (e.g., the left eye) and that the same set of operations are performed concurrently for the other eye (e.g., the right eye).

The highlighted regions 1101A-B of two of the images in the top row of images 1101 indicates the overlapping portions of each image that will be used to identify the stitch. In one embodiment, the width of these regions is set to some fraction of the overall width of each image (e.g., ¼, ⅓, ½). The selected regions include overlapping video content from adjacent images. In one embodiment, the GPU aligns the left image with the right image by analyzing and matching this content. For example, one implementation performs a 2D comparison of the pixel content in each row of pixels. One or more feature points from a first image region (e.g., 1101A) may be identified and used to identify corresponding feature points in the second image region (e.g., 1101B). In other implementations (some of which are described below) a more complex matching model may be used such as belief propagation.

Image rectification 1102 is performed, projecting the images 1103 onto a common image plane. Following rectification, a stitcher 1104 implemented by the GPU uses the designated regions of adjacent rectified images 1103 to match pixels (in accordance with a specified matching algorithm) and identify the correct orientation and overlap between the rectified images 1103. Once the image overlap/orientation is identified, the stitcher 1104 combines each adjacent image to form a plurality of stitched, rectified images 1105. As illustrated, in this particular implementation there are two ½ image portions 1105A-B remaining at each end of the panoramic video.

A cylindrical projector 1106 then projects the stitched images 1105 onto a virtual cylindrical surface to form a smooth, consistent view for the end user in the final panoramic video image 1107.

The embodiments described above may be implemented in software executed on the GPU(s) 1005, by fixed function circuitry, and/or a combination of software and fixed function circuitry (e.g., with some stages being implemented in hardware and others in software). Although not illustrated in the Figures, the data for each image may be stored in a system memory, a caching subsystem on the GPU(s) 1005, a local GPU memory, and/or a GPU register file.

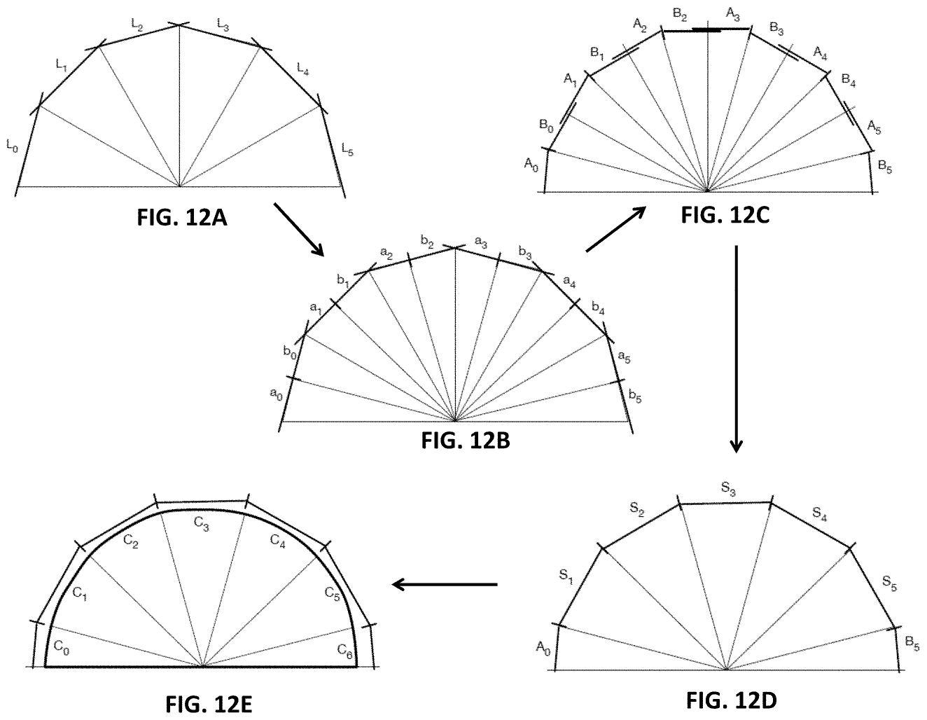

FIGS. 12A-E illustrate the effects of this sequence of operations on the video images from an elevated perspective (i.e., looking down in a direction parallel to the image planes). In particular, FIG. 12A illustrates six input images {Lᵢ}⁵ᵢ₌₀. In one embodiment, correction for lens distortion is performed on the input images at this stage.

In FIG. 12B, each image is split in half vertically (ai, bi)=split(Li) and in FIG. 12C, each pair (bᵢ, aᵢ₊₁)⁴ᵢ₌₀ is rectified by a “virtual rotation” about each view's y-axis (which is equivalent to a homography operation). The two end portions A₀ and B₀ are also rotated but are not involved in stitching. The following code specifies the operations of one embodiment:
for i=0 . . . 4
Bᵢ=rectify(bᵢ, □□, left) (□ is determine empirically)
   Aᵢ₊₁=rectify(aᵢ+1, □, right)
   A₀=rectify(a₀, □, right)
B₅=rectify (b₅, □□, left)

FIG. 12D shows stitching of rectified pairs Sᵢ₊₁=stitch(Bᵢ, Aᵢ₊₁)⁴ᵢ₌₀ in accordance with one embodiment. Note that this creates a “crease” at the original image centers, but numerically it is sufficiently precise to not create a “seam.” In one embodiment, these creases are removed by the cylindrical projection in the next operation (FIG. 12E). In contrast, prior stitching pipelines generated creases at the stitch which resulted in undesirable distortion and a lower quality stitch.

As illustrated in FIG. 12E, a full cylindrical projection is performed for the five stitched images and “half” cylinder projections for the two end images. This is shown as image frames S₁-S₅ being curved around the virtual cylinder to form C₁-C₅ and end image frames A₀ and B₅ being similarly curved to form C₀ and C₆, respectively. The seven resulting images are concatenated together to form the final panoramic image, which is then processed by the remaining stages of the pipeline.

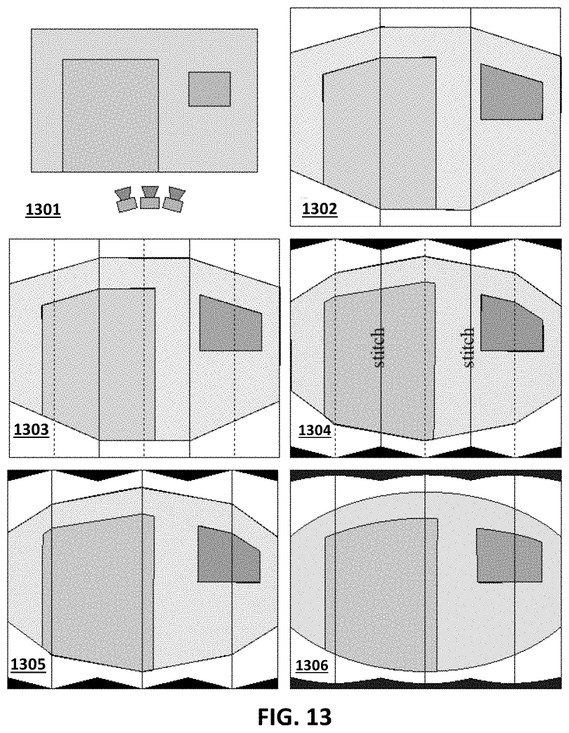

FIG. 13 illustrates another perspective using a simplified set of images 1301-1306 (i.e., captured with three cameras). Image 1301 shows the arrangement of cameras used to capture the video frames shown in image 1302 (overlap not shown). Each image is split vertically in image 1303. In image 1304, each image is transformed using a homography transformation which is a perspective re-projection that effectively rotates neighboring image planes so that they are parallel (see, e.g., FIG. 12C). This rectifies the images fed to the stitcher so that common features are aligned along the same image rows, which is an important operation for fast and accurate stitching.

In image 1305, neighboring images are stitched along their overlapping regions. Note that the homography results in “folds” along the original image center lines. Finally, image 1306 shows a cylindrical projection which is used to create the final panorama

Returning to the overall architecture shown in FIG. 10, following rectification, stitching, and cylindrical projection, the GPU 1005 performs RGB to YUV conversion to generate 6 splits (see, e.g., 1107 in FIG. 11). In one embodiment, an NV12 format is used, although the underlying principles of the invention are not limited to any particular format. In the illustrated implementation, a motion JPEG encoder 1007 encodes the image frames 1107 using motion JPEG (i.e., independently encoding each image frame without inter-frame data as used by other video compression algorithms such as MPEG-2).

The encoded/compressed video frames generated by the MJPEG encoder 1007 are packetized by Real-Time Transport Protocol (RTP) packetizer 1008 and stored in a buffer 1009 prior to being transmitted over a network/communication link to RTP depacketizer 1010. While RTP is used to communicate the encoded/compressed video frames in this embodiment, the underlying principles of the invention are not limited to any particular communication protocol.

The depacketized video frames are individually decoded by MJPEG decoder 1011 and scaled 1012 based on desired scaling specifications (e.g., to a height of 800 pixels in one embodiment). The scaled results are temporarily stored in a synchronization buffer 1013. An aggregator 1014 combines multiple video streams, potentially from different capture PODs 1001 and stores the combined streams in a temporary storage 1015 (e.g., such as the overlay buffer described herein).

In one embodiment, an H.264 encoder 1016 encodes the video streams for transmission to end users and a muxer & file writer 1017 generates video files 1018 (e.g., in an MP4 file format) at different compression ratios and/or bitrates. The muxer & file writer 1017 combines the H.264 encoded video with the audio, which is captured and processed in parallel as described directly below.

Returning to the audio processing pipeline, the stereo audio capture unit 1002 captures an audio stream 1003 simultaneously with the video capture techniques described herein. In one embodiment, the stereo audio capture unit 1002 comprises one or more microphones, analog-to-digital converters, and audio compression units to compress the raw audio to generate the audio stream 1003 (e.g., using AAC, MP3 or other audio compression techniques). An audio decoder 1004 decodes the audio stream to a 16-bit PCM format 1021, although various other formats may also be used. An RTP packetizer generates RTP packets in an RTP buffer 1023 for transmission over a communication link/network. At the receiving end, an RTP depacketizer 1024 extracts the PCM audio data from the RTP packets and an AAC encoder 1024 encodes/compresses the PCM audio in accordance with the AAC audio protocol (although other encoding formats may be used).

A media segmenter 1019 temporally subdivides the different audio/video files into segments of a specified duration (e.g., 5 seconds, 10 seconds, 15 seconds, etc) and generates index values for each of the segments. In the illustrated embodiment, a separate set of media segments 1020 are generated for each audio/video file 1018. Once generated, the index values may be used to access the media segments by clients. For example, a user may connect to the real time VR streaming service and be redirected to a particular URL pointing to a particular set of media segments 1020. In one embodiment, the network characteristics of the client's network connection may initially be evaluated to determine an appropriate set of media segments encoded at an appropriate bitrate.

As illustrated one or more metadata injectors 1030, 1040 insert/inject various forms of metadata to the media segments 1020. By way of example, and not limitation, the metadata may include the current scoring and other relevant data associated with the sporting event (e.g., player statistics, rankings, current score, time remaining, etc), information related to the musical performance (e.g., song titles, lyrics, authors, etc), and any other information related to the event. In a sporting implementation, for example, the scoring data and other relevant data may be displayed within a graphical user interface of the VR client and/or integrated directly within the panoramic video stream (e.g., displayed over the actual scoreboard at the event). Moreover, various types of metadata may be injected including HTTP Live Streaming (HLS) metadata injected by an HLS metadata injector 1030 and ID3 metadata injected by the ID3 metadata injector 1040.

In one embodiment, a push unit 1025 dynamically pushes out the various media segments 1020 to one or more cloud services 1026 from which they may be streamed by the VR clients. By way of example, and not limitation, the cloud services 1026 may include the Amazon Web Services (AWS) Cloud Front Web Distribution platform. The pushing of media segments may be done in addition to or instead of providing the media segments 1020 directly to the VR clients via the VR service provider's network.

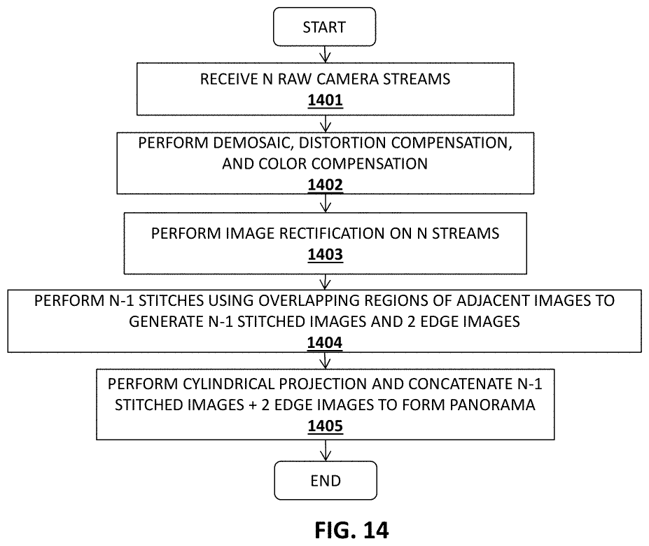

A method for efficiently and accurately stitching video images in accordance with one embodiment of the invention is illustrated in FIG. 14. The method may be implemented within the context of the system architectures described above, but is not limited to any particular system architecture. At 1401, N raw camera streams are received (e.g., for each of the left and right eyes). At 1402, demosaicing is performed to reconstruct a full color image from potentially incomplete color samples received from the cameras. Various other image enhancement techniques may also be employed such as distortion compensation and color compensation.

At 1403, image rectification is performed on the N streams and, at 1404, N−1 overlapping regions of adjacent images are processed by the stitching algorithm to produce N−1 stitched images and 2 edge images. At 1405, cylindrical projection and concatenation are performed on the N−1 stitched images and the two edge images to form the panoramic image.

### Stitching Using Belief Propagation

As mentioned, one embodiment of the invention employs belief propagation techniques to perform stitching of adjacent images. Belief propagation (BP) (or “sum-product message passing”), is a technique in which inferences are made on graphical models including Bayesian networks and Markov random fields. The belief propagation engine calculates a marginal distribution for each unobserved node, based on observed nodes.

In the context of image stitching, belief propagation is used to identify a most likely matching pixel in a second frame for each pixel in a first frame. Belief propagation has its own internal parameters which dictate how different variables are to be weighted to identify matching pixels. However, the results using standard internal parameters are not ideal.

To address these limitations, one embodiment of the invention performs modifications to the basic belief propagation parameters to generate significantly improved results. In general, there exists a tension between the accuracy of the pixel match and the smoothness/continuity of the seam. Choosing parameters which are weighted towards accuracy will result in degraded continuity and vice-versa. One embodiment of the invention chooses a set of “ideal” parameters based on the requirements of the application.

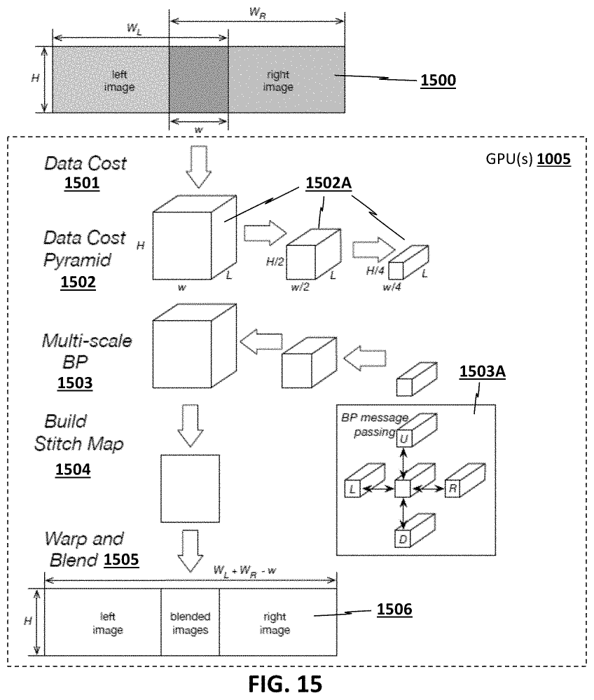

FIG. 15 illustrates the sequence of operations 1501-1505 performed by one embodiment of the Belief Propagation engine. These operations include initially performing a data cost evaluation 1501 where, for each pixel in the w×H overlapping region between the left and right input image 1500, a cost vector of length L is computed that estimates the initial cost of matching L different candidate pixels between the left and right images.

Each cost value is a real number (e.g., stored as a floating point number). There are many ways to compute this cost such as sum of absolute differences (SAD) or sub of squared differences (SSD). In one embodiment, the result of this computation is a w×H×L “cost volume” of real numbers.

One embodiment finds the index with the lowest cost (i.e., argminᵢ Lᵢ), but the result at this stage will be too noisy. A “consensus” will be developed between neighboring pixels on what the costs should be. Creating cost values that are more coherent or “cost smoothing” is the one of the primary functions of Belief Propagation.

The cost Lᵢ is converted into a probability 1/e^{Li} and normalized. The goal is to minimize the cost (energy minimization) or maximize the probability. Different flavors of Belief Propagation. One embodiment is described in terms of energy minimization, sometimes called the “negative log probability space.” One implementation also normalizes the colors to adjust for different brightness and exposures between cameras.

Furthermore, in one embodiment, the number of rows of the images being stitched are down-sampled by a factor (e.g., 2, 3, 4, etc) to speed up the process, thereby reducing the memory footprint and enhancing tolerance for misaligned frames. It is assumed that the images have been rectified so that common features are on the same scan lines (i.e., epipolar lines match and are parallel). Additional image processing may be done at this stage as well such as implementing a high-pass filter to reduce noise from cameras (e.g., charge coupled device (CCD) noise).

Following data cost analysis 1501, a data cost pyramid is constructed at 1502. In one embodiment, starting with the initial data cost volume, a series of smaller volumes 1502A are constructed of size {w/2×H/2ⁱ×L|i=0 . . . } that make up the data-cost pyramid by averaging/down-sampling cost values. Note that the cost vectors are still of length L for all volumes in the pyramid.

Starting with the smallest volume in the data-cost pyramid, several iterations of Belief Propagation message passing 1503A are performed. The results are then up-sampled to the next largest volume at 1503 and Belief Propagation message passing 1503A is performed again using the up-sampled values as a starting point. For each step four more volumes are created to hold the messages that are passed up, down, left, and right between neighboring cost vectors. Once the iterations are complete, the final costs are computed from the original cost volume and the message volumes. These are used to seed the iteration at the next higher level.

When the final results are generated, a stitch map is constructed at 1504. In one embodiment, the optimal label i is determined for each pixel by computing the “final beliefs” via i=argminᵢ Lᵢ. These indices i identify which two pixels form the best correspondence between the original left and right images in the overlap region. To speed things up, one embodiment short circuits the multi-scale Belief Propagation process by stopping the iterative process and forming the stitch map from a smaller volume. This results in a smaller stitch map that can be bi-linearly sampled from when stitching. In one embodiment, the stitch map is sorted in a hardware texture map managed by the GPU(s) 1005.

The final image is then stitched by performing warping and blending in accordance with the stitch map 1504 to generate the final stitched image frame 1506. In particular, for each pixel in the overlapping region the stitch map is used to determine which two pixels to blend. One embodiment blends using a convex linear combination of pixels from each image:

result pixel=(1−t)*left pixel+t*right pixel,

where t varies from 0 to 1 when moving from left to right across the overlap region. This blend biases towards left pixels on the left edge and biases towards right pixels on the right edge. Pixels in the middle are formed with a weighted average. Laplacian Blending is used in one embodiment to reduce blurring artifacts.

In one implementation, a completely new stitch is performed for every frame. Given the significant processing resources used to identify the stitch, one embodiment of the invention feeds back the previous stitch parameters for one or a combination of previous frames to be used to stitch the current frame.

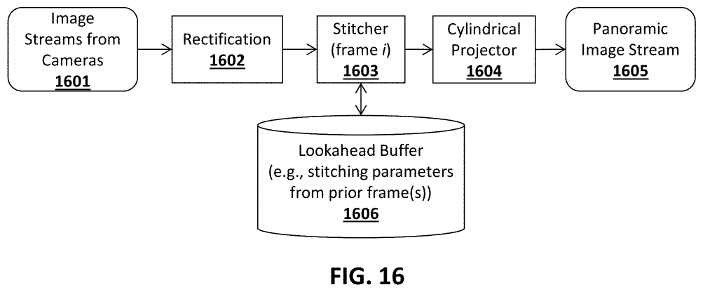

FIG. 16 illustrates one embodiment of an architecture which includes rectification circuitry/logic 1602 for performing rectification of images streams from the cameras 1601 (e.g., of one or more capture PODs) and stitcher circuitry/logic 1603 which stores stitching parameters from prior frames to be used as a starting point. In particular, a lookahead buffer 1606 or other type of storage is used by the stitcher 1603 to store parameters from previous stitches and read those parameters when processing the current set of image frames. For example, the specific location of a set of prior feature points may be stored and used to identify the stitch for the current image frames (or at least as a starting point for the current image frames).

In one embodiment, the parameters from previous stitches may simply be the parameters from the last stitch. In another embodiment a running average of these parameters is maintained (e.g., for the last N stitches). In addition, in an implementation which uses belief propagation, the previously-determined depth map pyramids shown in FIG. 15 may be reused.

In one embodiment, blending between adjacent images is used when a stitch fails. A failed stitch may occur, for example, due to insufficient information, disparate lighting (which may be temporary), and any other circumstances where similarities between pixels cannot be determined.

In response to a failure, one embodiment of the invention analyzes the previous and next scan lines and blends them together. Different types of blending may be selected based on characteristics of the two frames. The blending may include (but is not limited to) linear blending, Laplacian blending, and Gaussian blending. Alternatively, or in addition, when pixels cannot be differentiated, the stitch parameters from one or more prior stitches may be used (as described above).

In one embodiment, the luminance (Y) plane is used to perform stitching operations, excluding the U and V planes, to reduce the amount of data required for stitching. Color does not provide significant value for stitching, unless certain types of operations such as background subtraction are used. Thus, the stitching pipeline is optimized with YUV requiring less memory and less time for conversions.

In one implementation, if two Y values from the two frames are identical or within a specified threshold, the U and the V values may then be evaluated to provide further differentiation between the pixels (e.g., to determine whether they have similar/same colors) thereby providing a more efficient culling mechanism (i.e., to cull candidates which are outside of the threshold).

One embodiment the invention quantifies stitch accuracy, potentially evaluating each seam down to a single number. As the stitch is changed, this embodiment searches for patterns, evaluates the associated numbers and identifies the one with the highest quantity as the stitch. This may be performed for each scan line where the belief propagation algorithm determines the extent to which this is a good stitch (i.e., quantifies the stitch accuracy).

Different types of variables may be evaluated to arrive at the number including data cost (how well left matches right pixel) and smoothness (how well two neighboring pixels agree).

### Bandwidth Reduction and Failure Recovery

In circumstances where network bandwidth is severely limited and/or in cases where one of the camera streams is non-functional or occluded, one embodiment reproduces one stream (e.g., which is occluded) using video streams from one or more adjacent cameras. For example, in one embodiment, in response to detecting that a stream from camera N is detected (e.g., the left eye stream in a left/right stereoscopic pair of cameras) one embodiment of the invention performs an image transformation on the stream from adjacent cameras N+1 and/or N−1 to reproduce the camera N stream.

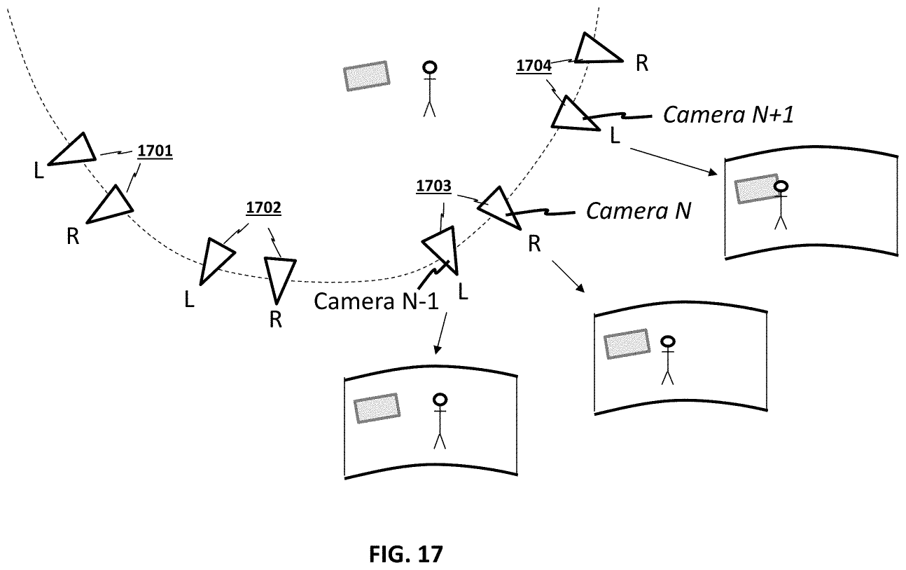

FIG. 17 illustrates an example arrangement in which a plurality of left/right cameras 1701-1704 capture an event from different viewpoints. An image of a stick figure is captured relative to a grey rectangle. These two objects are used to illustrate the manner in which the perspective changes from camera N−1 to camera N+1. For example, in the video stream from camera N−1, there is a larger separation between the two objects while from camera N+1, there is no separation (i.e., the user is occluding a portion of the rectangle).

It can be seen from this arrangement, that there is a significant overlap in the image data captured by cameras N, N+1, and N−1. The embodiments of the invention take advantage of this overlap to reduce bandwidth and/or compensate for the failure or camera N. For example, per-camera transformation matrices may be calculated prior to an event based on the orientation differences between a first camera (e.g., camera N) and one or more adjacent cameras (e.g., camera N+1). If the differences in orientation of the two cameras is known (e.g., X, Y, Z vector defining the 3D direction each camera is pointing, the distance to the event objects from the cameras, etc) then these differences may be used to generate a transformation matrix for camera N which can be used to reconstruct it's video stream.

In one embodiment, two transformation matrices are generated for camera N: one for camera N+1 and one for camera N−1. Using two cameras ensures that all of the necessary video data will be available to reconstruct camera N's video stream. However, in other embodiments, only one video stream from one adjacent camera is used. In this case, the camera selected for the reconstruction should be the corresponding left/right camera. For example, if camera N is a left eye camera, then camera N+1 (used for the transformation) should be the corresponding right eye camera. Choosing the alternate eye camera makes sense given the significant correlation in orientation between the left/right cameras. If there are portions of the image which cannot be reconstructed, these portions may be identified in the video stream from camera N−1 (e.g., the right camera of the adjacent pair of cameras). The camera N matrix associated with camera N−1 may be used to fill in any holes in the transformation performed on the video stream from camera N+1.

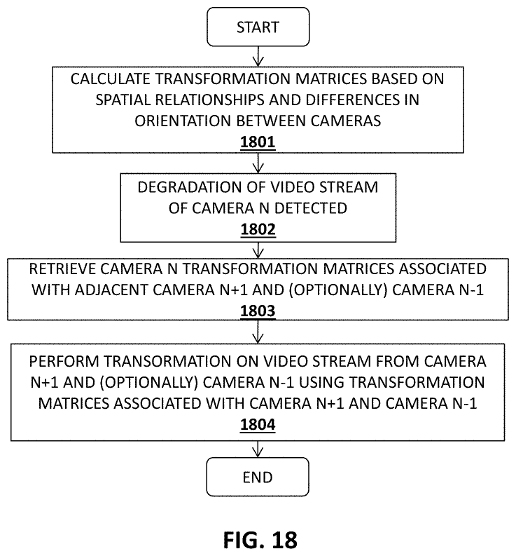

A method in accordance with one embodiment of the invention is illustrated in FIG. 18. At 1801, transformation matrices are calculated for each camera, based on spatial relationships and differences in orientation between cameras. At 1802, a degradation of a video stream of camera N is detected. For example, camera N may have failed or may there may be bandwidth issues with the network link.

At 1803, the transformation matrices associated with adjacent cameras N+1 and N−1 are retrieved and, at 1804, a transformation is performed on one or both of the video streams from camera N+1 and camera N−1. For example, the camera N matrix associated with camera N+1 may be used to transform camera N+1's video stream using the transformation matrix to reconstruct the video stream from the perspective of camera N. In one embodiment, the camera selected for the reconstruction is one of the left/right pair. For example, if camera N is a left eye camera, then camera N+1 (used for the transformation) is the corresponding right eye camera. Choosing the alternate eye camera makes sense given the significant correlation in orientation between the left/right cameras.

If there are portions of the image which cannot be reconstructed, these portions may be identified in the video stream from camera N−1 (e.g., the right camera of the adjacent pair of cameras). The camera N matrix associated with camera N−1 may be used to fill in any holes in the transformation performed on the video stream from camera N+1.

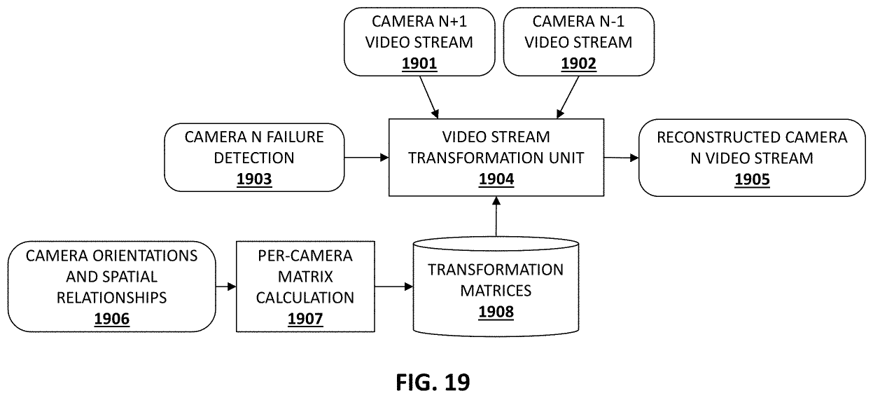

FIG. 19 illustrates an example architecture which includes a per-camera matrix calculation unit 1907 for calculating the various transformation matrices 1908 described herein based on the camera orientations and relative spatial relationships of the cameras 1906 (as described above). In one embodiment, the transformation matrices 1908 are stored for later use.

In response to a failure detection unit 1903 (e.g., a microservices-based monitoring system) detecting a failure of camera N, a video stream transformation unit 1904 reconstructs camera N's video stream based on the video streams of camera N+1 and camera N−1. As mentioned above, the camera N matrix associated with camera N+1 may be used to transform camera N+1's video stream using the transformation matrix to reconstruct the video stream from the perspective of camera N. If there are portions of the image which cannot be reconstructed, these portions may be identified in the video stream from camera N−1. The camera N matrix associated with camera N−1 may be used to fill in any holes in the transformation performed on the video stream from camera N+1.

The techniques described here may be used for a variety of circumstances including, but not limited to insufficient bandwidth, occlusion by objects, and/or equipment failures. While the embodiments described above focus on a camera failure, one embodiment performs the techniques described herein for the sole purpose of reducing bandwidth.

In addition, in one embodiment, the techniques described above are used for efficiently storing video streams of an event for later playback (e.g., after the event has ended). The amount of mass storage space consumed by 6-12 5 k video streams is significant. Moreover, in one implementation, capture PODs capture video using motion JPEG (see, e.g., FIG. 10, and MJPEG encoder 1007) which consumes significant bandwidth and storage space.

To reduce bandwidth, only a subset of the camera video streams are recorded for subsequent playback. When a user chooses to watch the recorded event, the transformation matrices are used to reconstruct those video streams which were not recorded. For example, only the left eye cameras may be recorded, and the transformation matrices may be used to reconstruct all of the right eye video streams.

In one embodiment, assuming that each left/right stream was captured, then a difference calculation unit may determine differences between the left and right streams. These differences can then be stored along with one of the two streams. For example, a disparity between adjacent streams (potentially from different pods) may be calculated and only one complete motion jpeg stream may be saved/transmitted. The other stream may be saved using differences between the motion jpeg stream and then reconstructed at the decoder, thereby removing a significant amount of redundancy.

Depth maps may also be generated and used by the algorithm to perform reconstruction of the original stream(s). For example, a monoscopic feed and a depth map may be used to reconstruct a stereo feed. The resolution of this depth map can be quite low. Disparity every inch, for example, is not required. At a low granularity, the depth map can be encoded using 8 bits total (e.g., granularity of 5-10 feet). Special types of processing may be performed for occluded objects (e.g., switching to data reduncancy).

### Key and Fill Compositing

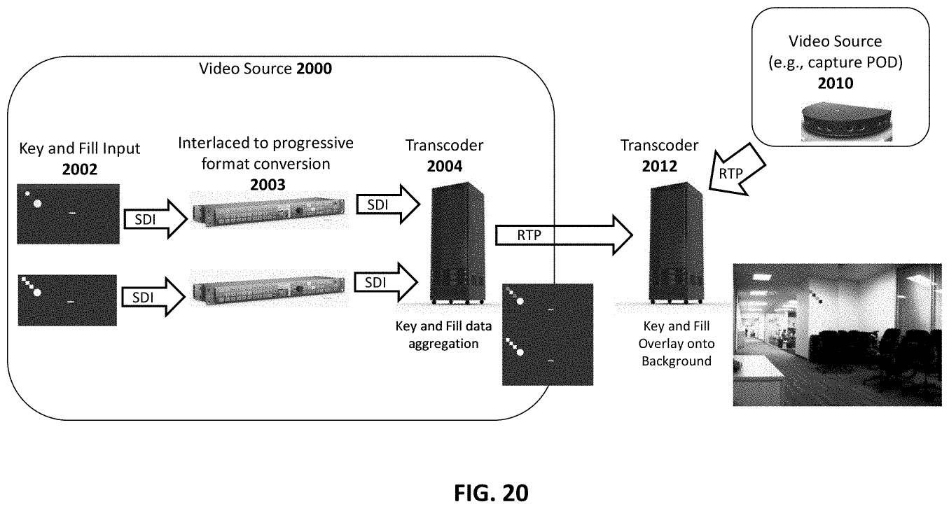

Referring to FIG. 20, one embodiment of the invention includes multiple transcoders 2004, 2012 to composite video or graphics from another source as a key and fill operation to the synchronized multi-camera VR feeds described herein. In one embodiment, the key is implemented as an alpha channel and fill is implemented as the color channel. A first video source 2000 receives key and fill input 2002 from one or more sources. Video processing circuitry/software 2003 equipped with a serial digital interface (SDI) (potentially on an SDI card) performs interlaced-to-progressive conversion. In one embodiment, this is accomplished by one or more Teranex standards converters, although the underlying principles of the invention are not limited to any particular digital video formats or converters.

After conversion, the progressive video streams are sent via one or more SDI outputs to a first transcoder 2004 which performs key and fill data aggregation on the inputs. The resulting stream is packetized and transmitted to a second transcoder 2012. In one embodiment, the Real-time Transport Protocol (RTP) is used for packetization and streaming, although the underlying principles of the invention are not limited to any particular transmission protocol. The second transcoder 2012 also receives a “background” video stream from a second video source 2010 which, in one implementation, is video captured by one or more capture PODs 1001. The second transcoder 2010 then overlays the key and fill stream onto the background video stream, effectively allowing different types of graphics and graphical effects to be displayed within the panoramic virtual reality image. In one embodiment, the overlay and background video are synchronized.

Parallax can be applied to the overlay so that the view can include depth effects within the panoramic virtual reality video. The composited video or graphics can be used to show event-related, real-time data (such as a game clock, score, statistics, or other relevant data) or can be used as virtual jumbotron and/or a virtual advertisement board.

In one embodiment, the background video is in received in a stereo format, with a left eye view and a right eye view. The overlay video received from video source 2000 may have two channels, one for color and one for transparency. The two videos are timestamped by a single synchronizer and transported over RTP. The transcoder 2012, which may be a compositing video server, receives and aggregates (buffers) timestamped video frames from both sources 2000, 2010 and finds matching frames based on the timestamps to composite the overlay video over the background video. When the overlay is composited, one embodiment of the transcoder 2012 applies parallax to the overlay (e.g., by locating the overlay in slightly different positions for the right and left eyes) to give the viewer a sense of depth in the virtual reality scene.

The embodiments described above provide the ability to composite video or graphics from another source as key and fill using the alpha channel and color channel, respectively, to the synchronized multi-camera virtual reality feeds (video source 2010).

Some embodiments described herein employ a distributed architecture in which service components are accessed remotely through a remote-access protocol, so these components can communicate across different processes, servers and networks. Similar to Object-Oriented Design (OOD) in software architecture, distributed architectures lend themselves to more loosely coupled, encapsulated and modular applications. This in turn promotes improved scalability, modularity and control over development, testing, and deployment of back-end service modules.

In the context of a service-based architecture for a distributed VR broadcasting system as described herein, portions of the overall architecture may be encapsulated into independent services. For example, a first Microservice is used for heart-beat injection, a second Microservice for capture controls, a third Microservice for meta-data injection, and a fourth Microservice for real-time operation monitoring. All services may be developed and maintained independently but designed to work with the overall system.

This service-oriented approach is beneficial for a variety of reasons. First, different programming languages can be used for different services (e.g., C++, C#, Swift, etc). This works particularly well in environments where different team members have expertise in different areas. While some engineers are adding more features to one Microservice others can work on other Microservices concurrently. This helps parallelize the development effort for different deliverables.

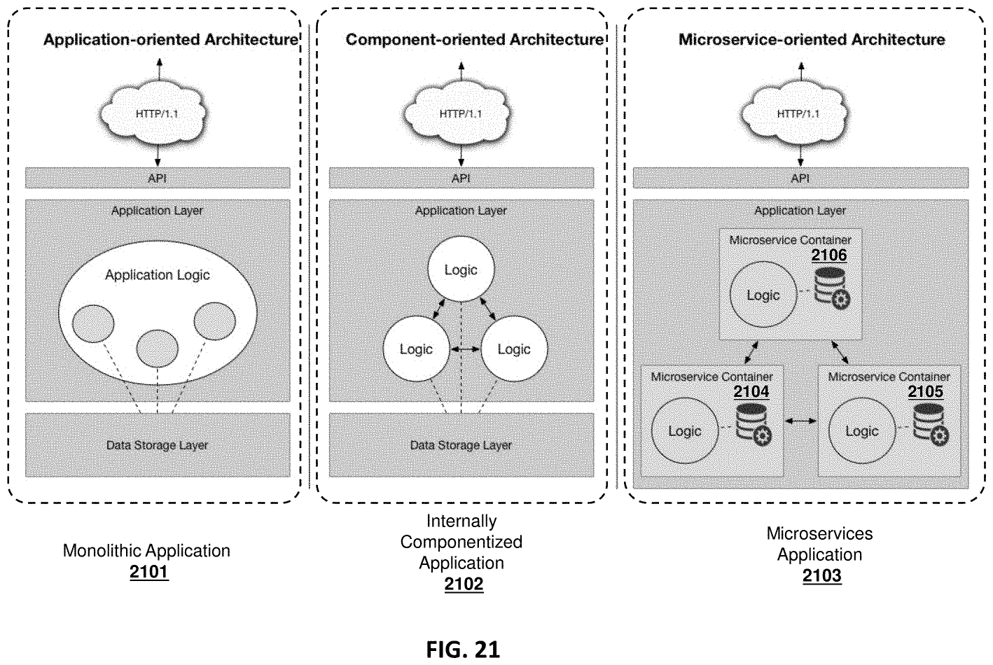

One of the differences between microservices and service-oriented architecture (SOA) is service granularity. The principle for microservices is to take the modularity of service-oriented architecture further into smaller and more manageable functional units. The concept of microservices, as compared with monolithic application 2101 and internally componentized application 2102, is illustrated in FIG. 21. The illustrated microservices application 2103 comprises a plurality of interconnected microservice components 2104-2105 which may be independently executed and updated.

### System and Apparatus for User Controlled Virtual Camera for Volumetric Video

The embodiments of the invention allow a user to interactively control their view and experience of an actual event in a volumetric space. The viewing can be imported or streamed to a VR head-mounted device with 6DOF or on mobile devices such as iPhone or Samsung Galaxy devices. With the embedded sensors of these devices, a user can select a vantage point within the volumetric space as the event is being played back in virtual space. This kind of user interactivity with video content in a volumetric space supports an array of innovative and new usages. For example, the user is provided with the ability to interact with objects in virtual space realistically, control the playback of streamed content, choose the best starting view to begin navigation, view additional player statistics, enjoy ambient audio from virtual speakers, and customize the experience of what one can see and hear in a live sporting event. These embodiments elevate the sporting event viewing experience to a new level.

In one embodiment, original event data is captured by cameras and microphones. The original event is converted to point cloud data (e.g., a set of data points in 3D space) and imported into a virtual reality head-mounted display with six degrees of freedom (6DOF). Note, however, that the embodiments of the invention may be implemented on various other types of head mounted/mobile devices. One embodiment of the invention allows the interactive movement of the user within the volumetric space as the event is rendered in the virtual space around them. The user may select their own vantage point either by physical movement within the virtual environment or by indicating a “jump” across a longer distance via a cursor rendered on the field (or other region of the sporting event) displayed within the virtual environment.

In one embodiment, the point cloud data used for the volumetric environment is generated from a plurality of cameras distributed throughout the event (e.g., 30, 35, or more cameras). In one embodiment, the point cloud data is streamed to a client-side application which renders the environment from the perspective of the user's vantage point. Alternatively, or in addition, the rendering may be performed on a server in response to control signals received from the client and the resulting video stream may be streamed to the client. In one implementation, the client-side application includes a graphical user interface overlay with a full suite of spatial navigation and time controls. It may be rendered either live in real time or played on demand from recorded data later.

Certain aspects of the panoramic VR broadcast system described above may be used to capture, compress and distribute audio/video content for generating and managing the point cloud data as described below. However, the underlying principles of the invention are not limited to these specific details and, in fact, some aspects of the above-described systems are not used in the below implementations.

The screenshots illustrated in this application comprise results generated from an actual implementation of one embodiment of the invention (a football play). The stadium shown is generated from a pre-rendered 3D model used to improve aesthetic context.

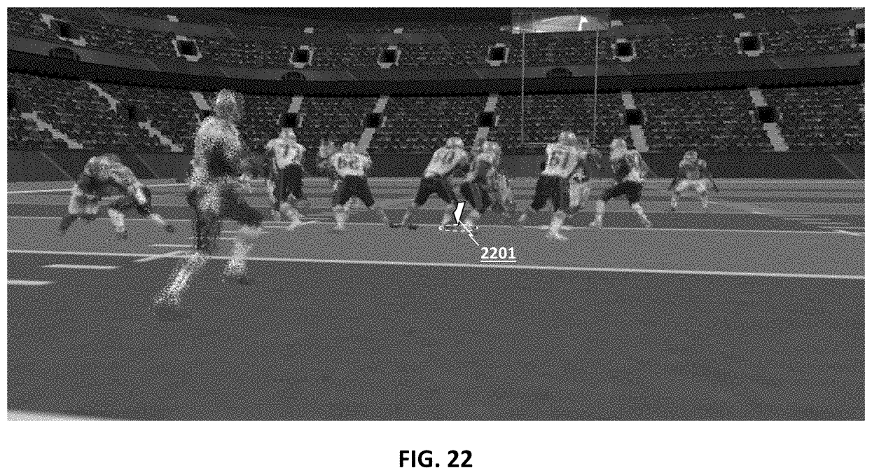

FIG. 22 illustrates a point in time shortly after the beginning of a play in a football game from a location behind the offense. Note that in FIG. 22, a cursor 2201 is rendered near the right foot of the offensive lineman wearing #60. In one embodiment, the cursor 2201 appears as a result of the user pointing the VR controls down at the field, and indicates a point to which the user's view may be moved to view the event from this location (e.g., from the perspective of lineman #60). When triggering a selection command (e.g., via a selection button on a handheld controller or other cursor control device), the virtual camera is moved to this point, where the user may resume looking around as the event sequence continues. In this example, the cursor displayed may be positioned anywhere on the football field, the sidelines, or the stands.

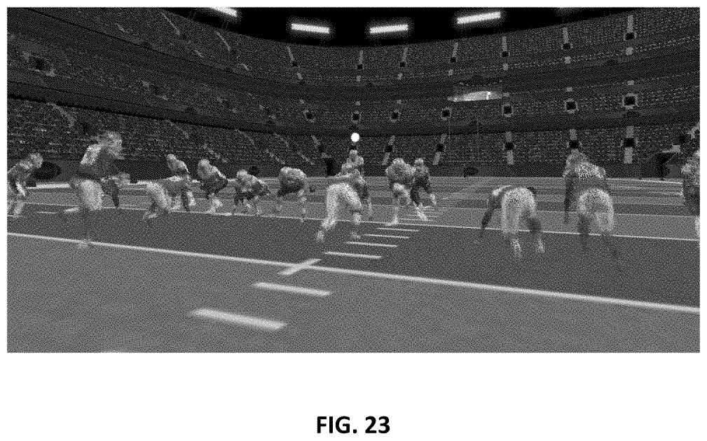

FIG. 23 illustrates the starting point from behind the defensive line at the beginning of the play. By manipulating an input device or performing a particular motion within the virtual environment, the user can jump between the offensive starting point (FIG. 22) and the defensive starting point (FIG. 23).

Note that FIG. 23 depicts an example where the start location of the user's viewing point is set to have the best viewing experience at the start of the sequence. This starting location gives the user the opportunity to view the most action by placing them in a location where they are most likely to see the most action—in this case behind the defensive line. The user controlled virtual camera experience can be created from either a system that captures and creates point cloud data (PCD) for a live event or from a storage endpoint that has the data available for on-demand access. For a compelling immersive experience, the embodiments of the invention capture and provides immersive video and audio content, enabling a combined visual and audio 6DOF experience.

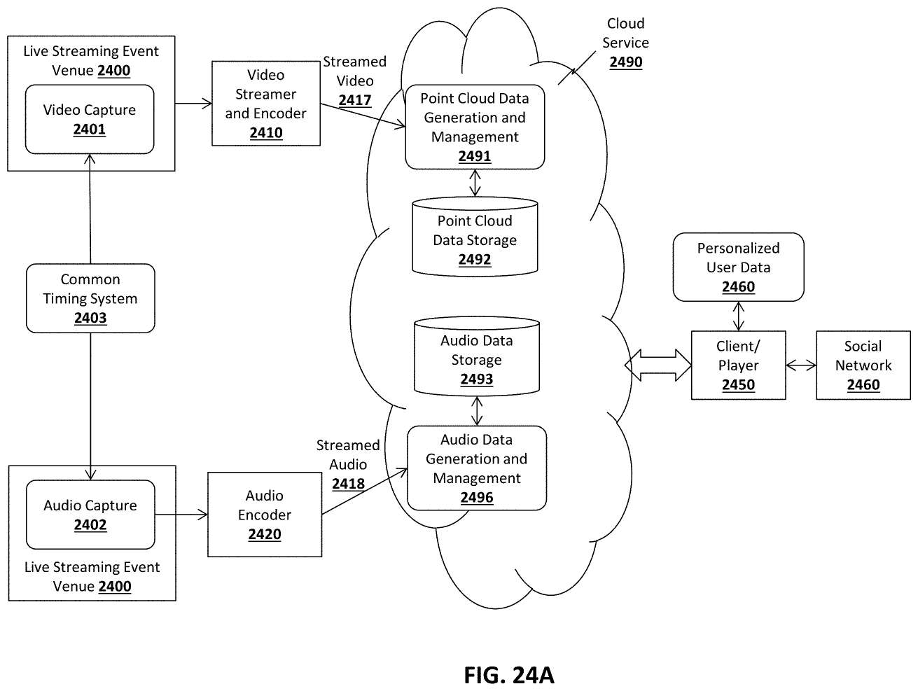

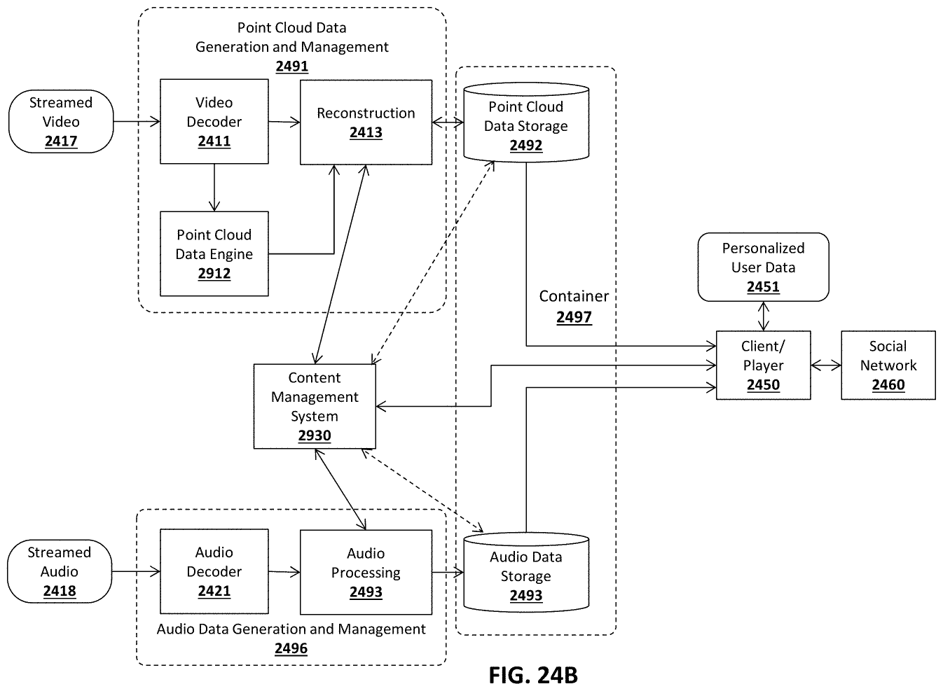

A system in accordance with one embodiment of the invention is illustrated in FIGS. 24A-B. By way of an overview, a video capture system 2401 comprising a plurality of cameras (e.g., 30, 40, 60 cameras, etc) coupled to a video streamer and encoder 2410 are strategically positioned at different locations at an event venue (e.g., a sporting event). The cameras of the video capture system 2401 capture sequences of images and transmit those sequences to the video streamer and encoder 2410 which compresses and streams the video to cloud service 2490. In one embodiment, the video is encoded with H.264 with embedded timestamps (described below) and is transmitted in accordance with the RTP/RTCP protocol or a reliable transport over TCP. The video streamer and encoder 2410 may utilize any of the techniques described above for capturing and processing video from a venue (see, e.g., FIG. 1, FIG. 10, etc).

An audio capture system 2402 comprising a plurality of microphones coupled to an audio encoder 2420 are also distributed throughout the event venue 2400 to capture audio from different perspectives. The microphones capture raw audio (e.g., PCM data) which the audio encoder encodes/compresses and streams to the cloud service 2490 (e.g., via Opus/RTP with timestamps).

In the illustrated embodiment, a common timing system 2403 is coupled to both the video capture system 2401 and audio capture system 2402 to ensure that the video frames captured by the video capture system 2401 and audio captured by the audio capture system 2402 can be synchronized during playback. In one embodiment, the video capture system 2401 stamps each video frame and/or packet (or every Nth frame/packet) with a timestamp provided by the common timing system 2403. Similarly, the audio capture system 2402 stamps each audio packet (or every Nth packet) with the timestamp.

The video streamer and encoder 2410 encodes/compresses the video and streams the video to the cloud service 2490 which includes a point cloud data generation and management system 2491 comprising circuitry and logic to generate point cloud data (as described herein). A point cloud database 2492 stores the point cloud data and provides the point cloud data to requesting clients/players 2450 under the control of a user. For example, the user may specify a particular location from which to view the event. In response, the corresponding point cloud data is streamed to the client/player 2450 for viewing by the user.

Similarly, audio data generation and management system 2496 within the cloud service 2490 decodes and stores the audio content within an audio database 2493. In response to a user request to view a particular portion of an event from a particular location on the field or the stands, the corresponding audio data is streamed to the client/player 2450, which synchronizes the video and audio streams using the timestamps, renders the video, and reproduces the audio for the user.

FIG. 24B illustrates additional details of one embodiment of the invention including a content management system 2930 for managing access to the data in the point cloud database 2492 and audio database 2493 as described below. A video decoder 2411 decodes the compressed video stream 2417 (e.g., using H./264 decoding) and provides the decoded video frames to a point cloud data engine 2912 and a reconstruction engine 2413. One embodiment of the point cloud data engine 2912 includes image analysis/recognition circuitry and software for identifying particular objects or groups of objects within each of the video frames such as particular players, each team, the ball, and different play views. In one embodiment, the point cloud data engine 2912 performs machine learning or other image recognition techniques to “learn” to identify different objects in different types of events.

Once the objects are identified, the coordinates for the objects are provided to the reconstruction engine 2413, which generates point cloud data files with timestamps (e.g., .pcd files, .ply files). It then stores the point cloud data files within the point cloud database 2492.

An audio decoder 2421 decodes the streamed audio 2418 to extract the timestamps (e.g., using AAC or other audio compression/decompression techniques) which it provides to audio processing circuitry/logic 2423. The audio processing circuitry/logic 2423 then stores the audio and timestamps to the audio database 2493 (e.g., streaming the audio data using Opus/RTP or other protocol). In one embodiment, a media container 2497 (e.g., MP4 or other multimedia container type) is formed which includes the point cloud data 2492 and audio data 2493. Containerization of the audio and video in this manner simplifies storage, copying, and/or moving the audio and video content within the cloud service 2490.

In one embodiment, the content management system 2930 manages the storage of the point cloud data in the point cloud database 2492 and the audio data in the audio database 2493. For example, the content management system 2930 establishes Hypertext Transport Protocol (HTTP) Representational State Transfer (REST) sessions with the reconstruction engine 2413 and/or point cloud database 2492 to manage/track storage of the point cloud data. Similarly, it establishes HTTP/REST sessions with the audio processing circuitry/logic 2423 and/or audio database 2493 to manage/track the audio data. As understood by those of skill in the art, representational state transfer (REST) defines a set of architectural constraints for creating Web services to allow interoperability between servers on a public or private network.

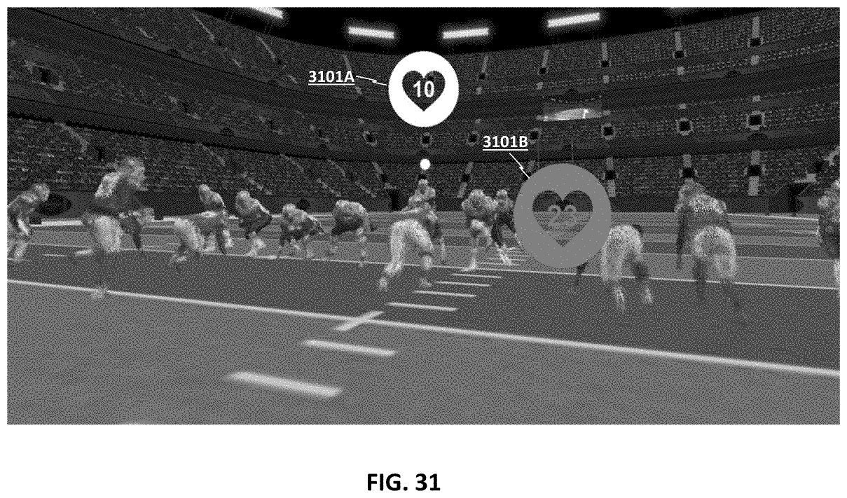

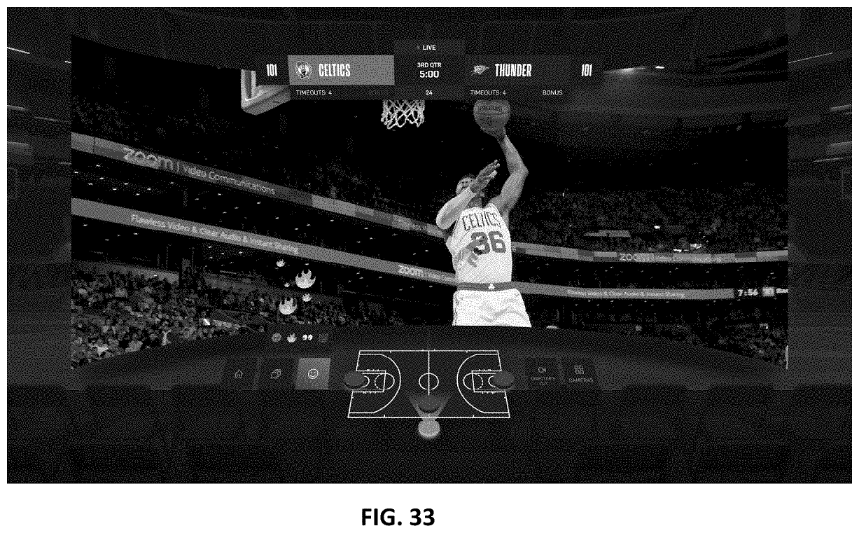

In response to a client request to view a particular event at a particular location on the field/stands at a particular point in time, the request is redirected to the content management system 2930 which provides metadata to the client 2450 (e.g., via an HTTP/REST transaction). In addition to providing the client 2450 with links to the point cloud data in the point cloud database 2492 and the audio data in the audio database 2493, the content management system 2930 may also provide relevant metadata related to the event, such as player and team statistics and the current score. Like the audio and video content, the metadata may be associated with timestamps indicating a time during the event corresponding to the metadata. The client 2450 then requests the point cloud data from the point cloud database 2492 and the corresponding audio from the audio database 2493. In addition, the GUI of the client 2450 may interpret the metadata and display it within the virtual event environment (see, e.g., FIGS. 31, 33 and associated text).

The following additional details may be included within each of the following system components. Note that these system components may be implemented in hardware, software, firmware, or any combination thereof. Moreover, these components may be distributed across interconnected servers (e.g., connected via a private and/or public network) and communicate via inter-server protocols such as HTTP/REST. Alternatively, or in addition, two or more of the described components may be integral, to the same server or other computing device. The underlying principles of the invention are not limited to the particular manner in which these components are implemented.

Additionally, while illustrated as separate discrete components, several of these components may be integrated within a single, cohesive system for performing the described operations. For example, in one implementation, the point cloud data storage 2492, audio data storage 2493, and content management system 2930 are integrated on a common platform (e.g., server or set of servers).

Live Streaming Event Venue 2400

This is a source location that has video and audio capturing capability via physical cameras and microphones installed and operated at the venue location. The video cameras 2401 may distributed strategically throughout the event venue 2400 and may be statically positioned and/or operated on dynamically adjustable devices such as moving platforms or video capturing drones. The microphones 2402, similarly may be physically positioned surrounding the venue to capture the sound of the event from different orientations.

Common Timestamping Source 2403

Assuming that content is captured by different systems for video and audio sources, a common clock/time source 2403 timestamps the captured video frames and corresponding audio samples. The timestamp indicates the time at which the content was captured and is subsequently used by the client 2450 to synchronize the content from these sources. As mentioned, metadata such as the current score and game events may also be captured and associated with these timestamps.

Video and Audio Encoding

Captured video and audio data in an uncompressed raw format is not suitable for a bandwidth-constrained data transport such as delivery over an IP network. In order to move the content to a remote location for the next stage of processing, the video can be compressed and encoded to a suitable format for data transport and processing. Thus, in FIG. 24, video encoding circuitry/logic 2410 compresses and encodes the raw video and audio encoding circuitry/logic 2420 compresses and encodes the raw audio content for transmission over a network communication channel.

Video Decoding 2411 and Audio Decoding 2421

The transported and compressed video and audio data are received by video decoding circuitry/logic 2411 and audio decoding circuitry/logic 2421, respectively, which decompress the video and audio, respectively. The decoding circuitry/logic 2421, 2411 comprise endpoints that handle packet/data loss and any packet transport reliability requirements. The received content is decoded and may be transformed into a suitable format for the next stage of processing. In particular, the decoded video is provided to a reconstruction engine 2413 and a point cloud data engine 2412 and the decoded audio is provided to an audio processor 2423, described below.

Reconstruction Engine 2413

During the stream processing stage, the reconstruction engine 2413 processes and converts the video streams to point cloud data 2492 stored on a point cloud data storage system (e.g., a Cloud service). The reconstruction engine 2413 performs a variety of point cloud operations including (but not limited to) (i) cleaning of background images, (ii) 2D localization operations, (iii) 3D localization operations, (iv) segmentation, and (v) reconstruction.

In one embodiment, the reconstruction engine 2413 also receives information from the point cloud data engine 2412 which runs in parallel and provides information related to the visual content in the video such as the locations of various objects such as the ball and specific players. The reconstruction engine 2413 uses this information to generate and store additional metadata in the point cloud data which may be used to assist the client 2450 to identify relevant or interesting content in the point cloud.

The reconstruction engine 2413 also records or catalogs this information in the content management system 2430, which manages the content for the client 2450 to access from the point cloud data storage system 2492. In particular, the content management system 2430 may record data used to identify interesting or otherwise relevant views for the user to access. The start and end of a particular view may be identified using the timestamps recorded within the point cloud data itself. In addition, the content management system 2430 manages metadata associated with the content and pointers to relevant portions of the point cloud data 2492 and audio data 2493. This metadata and pointers are provided to the client 2450 upon request to allow the user to choose desired content and a desired view. Upon selection, the client 2450 generates a request and the associated video content is streamed from the point cloud data and audio content from the audio data 2493.

Point Cloud Data Engine 2412

One embodiment of the point cloud data engine 2412 receives video streams as captured from the venue and runs computer vision algorithms to identify and track interesting or relevant content in the streams. It then provides data identifying the interesting/relevant content to the reconstruction engine 2413. For example, the point cloud data engine 2412 can provide location information indicating the location of relevant objects which it has been trained to identify using image recognition techniques (e.g., using machine learning). The point cloud data engine 2912 may be trained or programmed to identify any relevant objects such as the ball and one or more players. Using this data, one embodiment of the reconstruction engine 2413 add metadata into the point cloud data 2492 indicating the location and other relevant information.

Content Management System 2430

One embodiment of the content management system 2430 catalogs and manages point cloud content which is made available for the client 2450 to access. The content management system 2430 may identify additional content to enhance the end-user experience. For example, player statistics or other external information that is not directly recorded in the point cloud data 2492 (e.g., weather data during the game) can be retrieved as needed by the content management system 2430.

Point Cloud Data Storage System 2492

In a live system, the decoded video frames are transformed by the reconstruction engine 2413 to point cloud data 2492, along with the additional metadata (e.g., timestamps and tracking information) provided from the point cloud data engine 2412. In one embodiment, all of this data is stored in the point cloud data storage system 2492. In one embodiment, the point cloud data 2492 is distributed redundantly across a plurality of servers in a Cloud service. Moreover, in one implementation, the point cloud data storage, audio data storage 2493, and content management system 2930 are integrated on a common server or set of servers.

In one implementation, the video content is not actively written to storage during a live game but is stored from an earlier recorded event. For example, the data may be retrieved from an external point cloud data source. The underlying principles of the invention are not limited to the temporal manner in which the video/audio data is processed and stored. The data must simply adhere to format and syntax requirements expected by the client 2450.

The point cloud data storage system 2492 may also provide data in a compressed format to deliver data more efficiently to bandwidth-constrained clients, such as mobile endpoints operating over wireless networks. In one embodiment, the point cloud data storage system 2492 stores the video content in a plurality of different bitrates and streams the bitrate most suitable for the client 2450 connection. In this embodiment, the bandwidth available to the client 2450 may be determined from the client or by implementing a series of transactions to test the bandwidth.

Audio Processor 2423

One embodiment of the Audio Processor 2423 processes the audio streams and, based on the physical location and orientation of the audio microphones 2402, it creates metadata comprising this location information which is associated with the relevant audio samples. The Audio Processor 2423 may also record or catalog this information in the content management system 2430 from which it may be accessed by the client 2450.

Knowledge of the physical location and orientation of microphones provides for a 6DOF audio experience when audio content is played based on the user's current viewing point within the point cloud data 2492.

Audio Data Storage 2493

The Audio Data storage 2493 is the storage endpoint for the audio samples accessed by the client. The content is cataloged in the content management system 2430 and is associated with relevant portions of the point cloud data 2492 via the common timestamps. Thus, when the user requests particular video content from a particular viewpoint, the video content is provided from the point cloud data storage 2492 and the associated audio data 2493 is provided from audio storage 2493. The client 2450 then uses the timestamps to synchronize the audio content and video content.

Client 2450

One embodiment of the Client 2450 renders the point cloud data 2492 to the user based on user control and actions. In one implementation, the client 2450 includes a virtual reality (VR) rendering engine and a VR headset in which to display the rendered point cloud images.

In one embodiment, the client 2450 accesses the content management system 2430 which provides a set of views/plays available in the point cloud data These views may be presented to the user for selection. Once selected, the client 2450 accesses the point cloud data 2492 based on this entry-point and/or starting time information.

The content that is accessed may be a live real-time stream or may be requested and retrieved on-demand from available stored data. As mentioned, the client 2450 also accesses the audio data 2493 which it discovers through a reference either from the content management system 2430 or through metadata stored within the point cloud data 2492. While the point cloud data storage 2492 and audio data storage 2493 are illustrated separately in FIG. 24, the same Cloud storage service may be used to store both the audio data 2493 and point cloud data 2492.

A personalized user data component 2451 stores user preferences such as preferred team(s) and favorite players. In one embodiment, the user preferences are collected and stored on the content management system 2930 when a new user account is established. In one embodiment, this information is used to identify specific content in the content management system 2430 (e.g., specific teams, specific clips of the team(s)/players) or can be used directly when this information is available from the metadata associated with the point cloud data 2492.

In one embodiment, the client 2450 also connects with a social networking service 2460 to allow a user to post and share views with friends or other social groups.

Personalized User Data 2451

The personalized user data 2451 includes information related to a user's preferences when accessing content from the point cloud data 2492. For example, when accessing an event calendar for sporting events, a user may prefer to access views from the perspective of a particular team or player. In one embodiment, this information is accessed by the client 2450 which uses the information to discover available content via the content management system 2430. In addition, the information may be used to identify content directly in the point cloud data 2492 when such metadata is stored therein.

Social Network 2460

The social network 2460 may be any third party external network of which the user is a member. The client 2450 may access these networks to share and post content from the point cloud data or related information.

User-Customized Virtual Camera

In one embodiment, a navigable menu is provided that allows the user to choose from pre-selected virtual cameras positioned at vantage points that are most interesting. Each virtual camera comprises a unique angle and may be customized to an individual user. From this starting view, the user may access the controls at any time to reposition as they like. The initial position may be configured based on the user's preferences, either explicitly entered into a client application that is being used to view the sequences, or based upon their past behavior in watching other content. For instance, if the user either has explicitly declared a favorite team, or has a known history of watching a particular team more often, the client 2450 may place the user's initial viewing position from that team's side of the field.

In one embodiment, a group of users may be associated with the same scene at the same time in a socialized setting, with each user able to see an “avatar” of another user displayed in the scene so that they know what each user is looking at. Each user has full control over their position from which to observe the action in progress, and can change at any time. The boundaries of the area users may select from may be configured by the presenters prior to viewing by users; in this example, it was configured to be the full area of the football field, but could be set to also include aerial views over the players' heads, spectator views from within the seating in the stadium, inside a luxury box over the field, or any other position desired by the presenters. For instance, a user may wish to position themselves further down the field to watch the receiver as he is about to receive the ball.

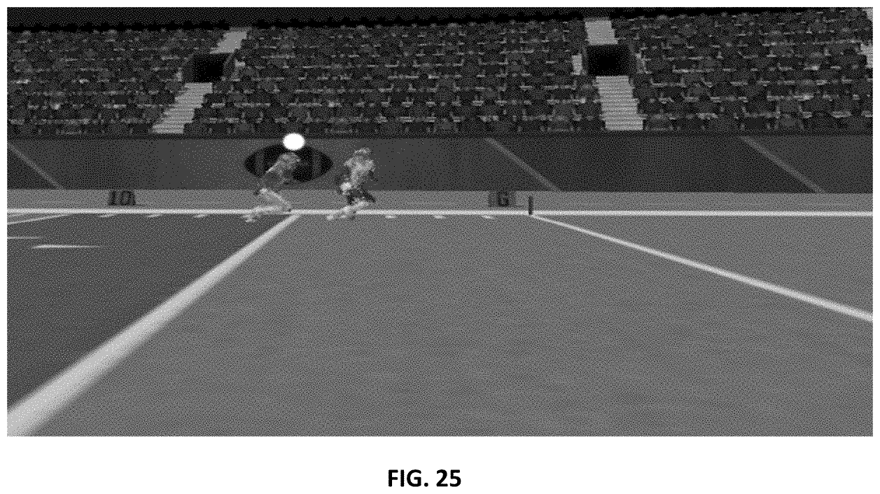

FIG. 25 illustrates an example comprising a view of a receiver downfield. While this example is drawing upon a single play from football, there is no structural reason that it need be limited to this orientation.

Time Control of Volumetric Video Sequence

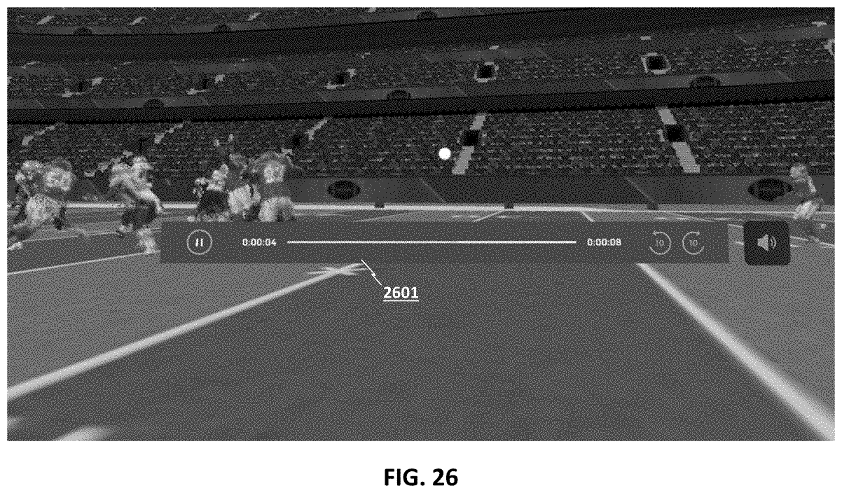

In one embodiment, the user is provided with control over the replay of the sequence. As shown in FIG. 26, at any time the user may provide input via an input device or motion to cause a user interface 2601 to be rendered. The user interface of this embodiment includes graphical video controls superimposed over the video content. The user may access these controls to pause, resume from pause, skip forward, or skip back in replay of the sequence.

These controls allow the user to stop the action at a particular point in time and continue to move about to re-examine the scene from different views within the field of interest. Controls for audio that may be edited into the scene, suggested camera angles, or any other additional elements of the overall experience may be included with this. There is no logical or structural limit on the possible vantage points; the given screenshots depict viewpoints as if the user were standing on the field, but views from overhead, from the stands, from a virtual “luxury box”, or anywhere else within line of sight may be presented.

Tagging of Object of Interest

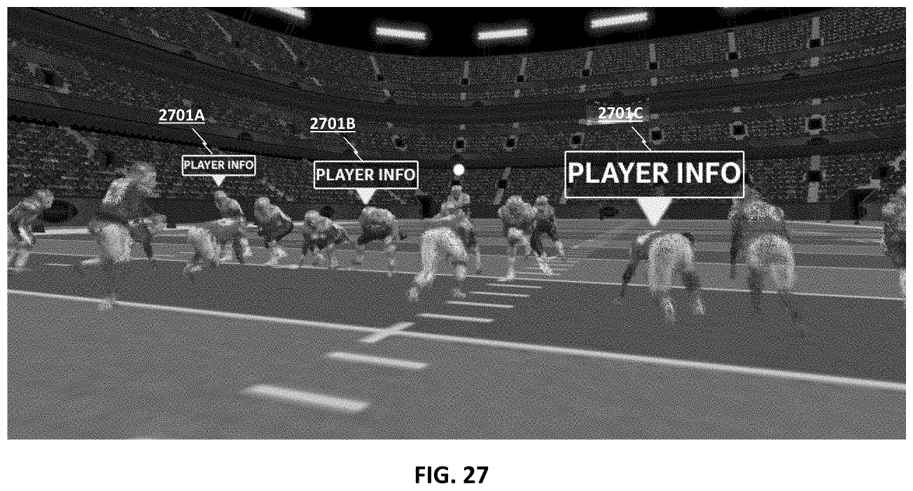

In addition, as illustrated in FIG. 27 “tags” 2701A-C may be added to the scene to direct the user's eye to people or objects of interest. For example, the quarterback could have his name and jersey number drawn in text that follows his position around the field. The receiver who catches the pass, the defender who follows him down the field, and any other players instrumental to the sequence of events can also be tagged with metadata. The metadata may be stored and managed by the content management system 2930 as described above.

By viewing and/or accessing these tags 2701A-C, the user is provided with the ability to learn more about the team, the players, and/or the event. A virtual “telestrator” may also be added to the scene to provide an explanation as to how an event unfolded in the way that it did, and where people within it made good or bad decisions that contributed to the end result. This data may be personalized for each user (e.g., stored as personalized user data 2470) so that different forms of metadata and graphics are provided to different users.

### Markers for Best View

In one embodiment, two types of cameras are made available as presets for viewing by the user:

1. PCAM (Physical Camera):

Cameras positioned in the venue physically. These may be static and/or dynamically movable in the venue. For example, static cameras may be pre-configured at locations around the venue while another set of cameras may be connected to camera positioning devices or held by camera workers and moved around the field during the event (e.g., coupled to adjustable wire systems above the field or on the sidelines).

2. VCAM (Virtual Camera):

Virtual cameras are those which are pre-defined by the producer (e.g., using a production tool) who positions them in 3D space anywhere within the event venue. These can also be static cameras (that stay at the same spot in 3D space) or they may follow cameras that follow the ball or a specific player in 3D space using the tracking data ingested by the Point Cloud Engine 2912.

Because not all PCAMs and VCAMs deliver the same interesting view of actions and events happening in the field, one embodiment of the invention includes a view ranking engine (e.g., within the point cloud data engine 2912) which ranks all of the views based on the best viewing angles for action during the game and/or other interesting events on the field. A set of the highest ranked locations may be identified with graphical markers so a user can pick a view to start navigation. A user may also preview the view of each marker location by going around all available views and then make choice to lock down a view.

One embodiment of the view ranking engine starts with player and ball detection using a Computer Vision Technology (CVT) engine to segment out objects in their bounding boxes. Based on a deep learning training model for player and ball, one embodiment of the view ranking engine gives an inference for the best view for users.

### Physics Engine for Objects in Volumetric Data

In one embodiment, the object segmentation for an object of interest in the volumetric data processed and generated by the point cloud data engine 2912 is used to create the bounding box for the object itself. The bounding box of an object is used to realistically give a presence of the object itself in the field of the event venue. In one embodiment, each VCAM also has a bounding box to mark its presence in the field such that the view of the VCAM bounces away from the bounding box of object when it bumps into the object This solves a problem which can result if the view of a VCAM passes through an object. Moreover, the bounce-back is animated using a physics modeling engine to give a more realistic user experience.

The bounding box may be provide to both augmented and real objects in the field, and invisible barriers may be added around the stadium to constrain where a virtual camera can move, similar to what a person can do in the real-world.

### Volumetric Augmentation

Volumetric augmentation is the insertion of visual elements into point cloud data, for display on HMD (Head Mounted Display), or mobile devices. Augmentation of the content allows for the insertion of various visual elements (examples of which are described herein) that allow for deeper storytelling that enhances the volumetric viewing experience. These augmentations can either be “in-perspective” 3D elements, or 2D “screen space” UI elements. Volumetric augmentation can also include 3D data visualizations of external data feeds, that are inserted into the point cloud. Examples of these volumetric augmentations include (1) Identifier Graphics (In-perspective), and (2) Identifier Graphics (2D screen-space UI).

(1) Identifier Graphics (In-Perspective)

Identifier graphics are the in-perspective pointers, and other visual elements that give relevant contextual information about an object in the 3D scene. Examples of these identifier graphics include:
a) pointers above objects,
b) content selection disks under object,
c) object trails,
d) volumetric highlights,
e) 3D sponsorship graphic inserts, and
f) 3D telestration.

In-Perspective augmentation can be both stationary, or track an object over time within the scene. For example, fan insights may be provided into tactically interesting situations. In this embodiment, multiple users may be watching the game in the volumetric space, analyzing the game flow and discussing the important situation of the game using the 3D telestration tools. This will enable user to draw 3D effects and graphics on the live video.

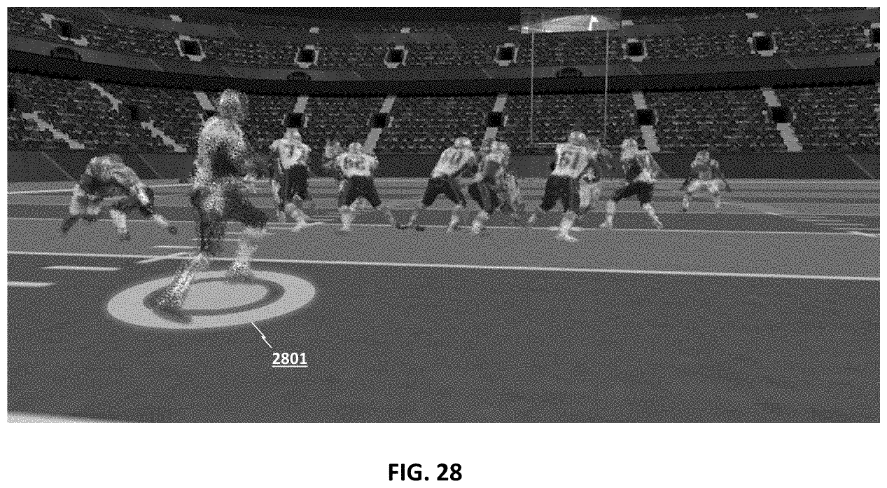

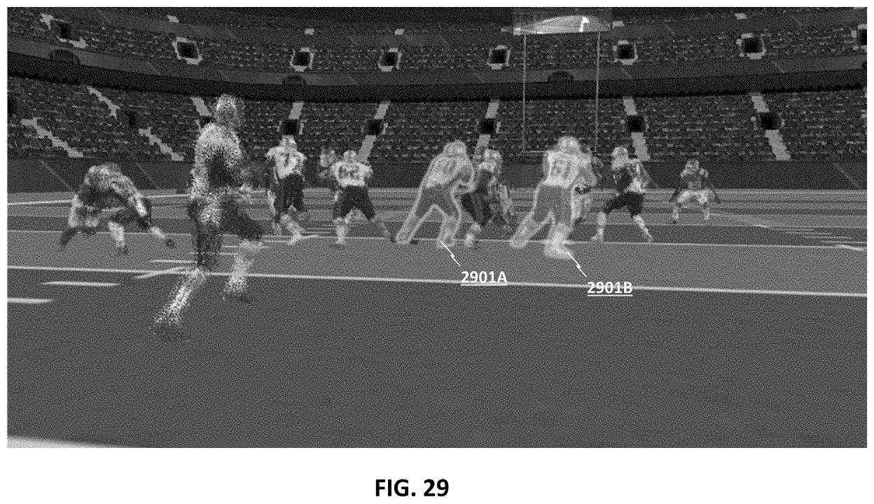

The player info tags 2701A-C shown in FIG. 27 are one example of in-perspective object identifier graphics. Another example of in-perspective augmentation is the content selection disk 2801 illustrated in FIG. 28. Yet another example is shown in FIG. 29, which shows in perspective volumetric highlights 2901A-B of two players.

(2) Identifier Graphics (2D Screen-Space UI)

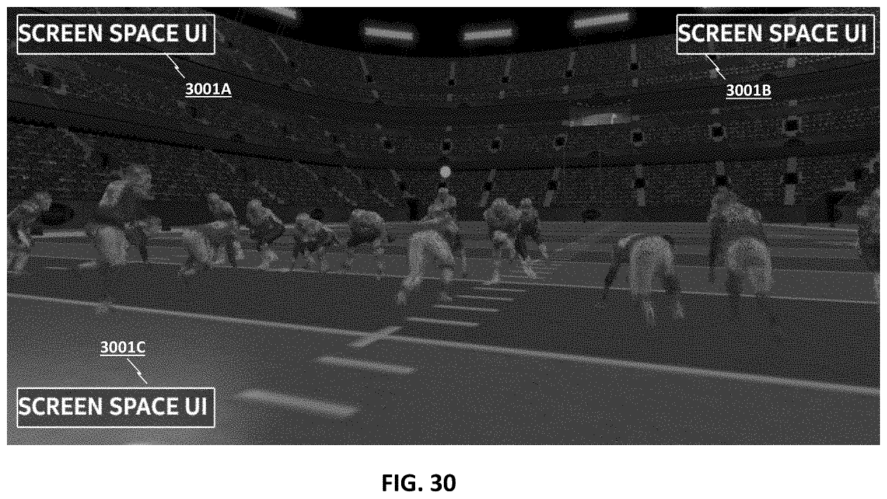

Identifier graphics are the 2D visual user interface elements displayed on a device's screen which provide relevant contextual information about an object (e.g., a player, team, etc). Examples of these identifiers include HUDs (Heads up Displays) of content derived from the volumetric point cloud, such as position, speed or location. FIG. 30 illustrates an example 2D Screen Space UI comprising 2D UI graphic elements 3001A-C rendered on top of the images on the device's screen.

### Volumetric Spatial Points of Interest

Volumetric spatial points of interest, generated in one embodiment, comprise multiple 3D audio points of interest within the volumetric point cloud for playback on a HMD, or mobile device. These various points of interest allow the user to experience contextual audio from different points of view, allowing for deeper immersion within the content. These areas of interest are represented in one embodiment as 3D volumetric audio spheres captured within the point cloud.

An example of a volumetric spatial point of interest for a football game includes context specific audio associated with different players. A user is provided with the ability to switch between the audio of a quarterback and wide receiver in a point cloud, and hear unique audio from the point of view of the quarterback or wide receiver, respectively. When a user selects a different point of interest, the audio transitions in sync with the 3D point cloud rendering.

### Crowdsourcing Collaborative Control

Crowdsourcing collaborative control is the ability for vantage points from within a volumetric experience to be sourced from individuals or from a group with a shared common interest, for HMD and mobile devices. These preferred volumetric vantage points can be gathered from users' data analytics or given by the user themselves, and provides users with the ability to curate their own volumetric experience of an actual real-word event. Since a piece of volumetric content can viewed from many more angles than a standard stationary camera, the system takes the most relevant data to provide users their best preferred vantage point. An individual is also provided the ability to share their personalized volumetric experience of an event with other users or experience others' shared vantage points. To identify these crowdsourced volumetric content vantage points, one or a combination of the following techniques may be used:
A. Voting Best Volumetric Viewing Angles
B. Personalized Volumetric Viewing Vantage Points
C. Augmenting Users' Sourced Data Analytics into a Volumetric Experience
D. Share Own and View Individuals' Volumetric Experience
E. Share Your Reactions within Volumetric Space

These capabilities provide individuals the tools to have a personalized storytelling experience of an actual ‘real-world’ event. The storytelling of the experience is left to the user to decide when they would like to take an active or passive role in their experience. By structuring a system that incorporates as many or as little recommendations of vantage points to experience a ‘real-world’ event from a different perspective. The ability to transverse an actual 6DoF event, whether it's live or post-production, provides users many options for vantage points from which to experience the volumetric content.

### A. Voting Best Volumetric Viewing Angles

Groups of users can collective come together to decide the best volumetric vantage point. These vantage points can also be sub-communities of the larger community to tailor a more preferred volumetric viewing vantage point that aligns more strongly with the preferences of the sub-community.

This functionality can also extend to allow sub-communities the capability to collectively challenge other sub-communities on where the best volumetric content vantage viewing point is located.

FIG. 31 illustrates graphic elements 3101A-B showing the results of crowd sourced voting on different camera viewing vantage points. Graphic element 3101A indicates that 10 users have voted for the perspective of the quarterback while 3101B indicates that 23 users have voted for the perspective of the defensive tackle.

### B. Personalized Volumetric Viewing Vantage Points

A tailored personalized volumetric viewing vantage point can also be derived from a user's pre-experience, during experience, and past-experience preferences. Pre-experience vantage angles can be sourced from user preference data that is relevant to an individual user. This vantages angels are identified by either or a combination of voluntary asked preferences or information universally available about the individual user.

During-experience vantage angles takes into consideration where and how an individual is currently interacting with a piece of ‘real-world’ volumetric content. These relevant pieces of information as in where to user is located, what the user is looking at, and how the user is consuming the content are taken into consideration in determining a vantage point for the user.

Example 1: Where the User is Located.

If a user has preference to an experience of Type A, but they are currently located in a spot that better suits those with preference of Type B.

The user will be indicated by either a visual or auditory cue to receive feedback that a more preferred vantage angle is available that closer aligns with their preferences.

Example 2: What is in a User's Field of View (FOV)

By tracking what is in a User's current FOV, the system can determine whether a user is looking at a vantage point that does or does not align with their content preferences.

The system is able to indicate to the user whether their current FOV is their preferred or there is a more preferred vantage angle available.

Example 3: How the User Consumes Volumetric Content

Being able to know if a user is sitting or standing gives height information about that user. The type of medium the user consumes volumetric content also adds an extra layer of vantage points that better suit mobile versus HMD experiences.

To enhance presence a user's pre-setup consuming preferences and during experience physical interactions determine preferred vantage points. This systems takes how a user is physical setup in the ‘real-world’ to affect their preferred vantage points in the volumetric world.

To determine a user's personalized vantage points clustering uses these labels to detect similarities in user's pre-experience, during-experience, and past-experience interactions to weight a user's preferred vantage point.

Example 4: Where is the user looking (Real time Eye/Head Tracking)

One embodiment of the invention takes advantage of eye or head tracking performed by the user's VR headset. This embodiment adds a sense of automation to camera selection in the experience where the camera moves/pivots to a location based on the current direction of the user's gaze. For example, if the user is looking at the right edge of the screen, the system rotates the camera to the right based on tracking of the user's eyes.

The same idea can be expanded to the concept of head tracking. Current VR systems can detect head movement. This data can be used for predictive analysis to switch cameras or move the user to a specific location in 3D space. For example, when a user is at the center of the field looking at a play but has been continuously looking at the right side, then one embodiment of the invention moves the user closer to that space or switches to a camera being offered near that space to automatically allow the user to see things closer to that space. It is assumed that either of the above two examples would not be enforced on the user but would rather be toggleable features that can be turned on or off as needed.

If the point cloud data is rendered locally on the client 2450, then the player application/app adjusts the current viewpoint in accordance with data received from sensors which track the direction of the user's gaze. Alternatively, if the point cloud data is rendered on a server and streamed to the client 2450 (e.g., as an H.264 stream), then the sensor data is transmitted to the server which uses the data to render the point cloud data in accordance with the current direction of the user's gaze.

C. Augmenting User-Sourced Data Analytics into a Volumetric Experience

Data analytics can be gathered from a group of users or a derived sub-group of a larger group to provide feedback to a user within the volumetric experience on how a group or sub-group is interacting with the volumetric content through audio and visual cues.

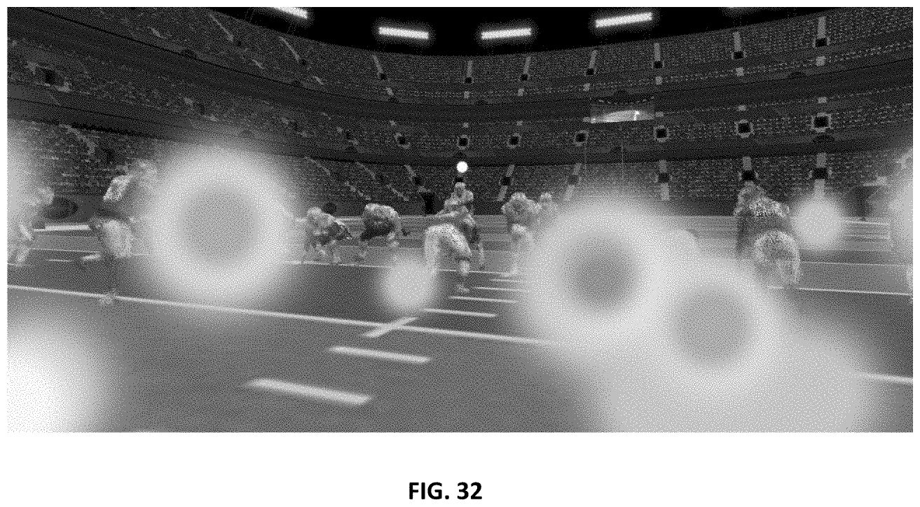

FIG. 32 illustrates a head map visualization showing the relative number of users looking at particular regions of the image.

Group and Sub-Group Heat Maps

A visual representation of where the most amount out of users' of groups you belong to, users' of groups that you do not belong to, and individually tracked users can be tracked in volumetric space over a duration of time and space. Similarly audio cues can also work to provide feedback that most users are located around a certain vantage point at a point of time and space.

This data representation can give users a sense of what vantage point they would prefer to experience.

### D. Share Own and View Individuals' Volumetric Experience

In one embodiment, users are given the ability to curate their own viewing vantage points through a volumetric experience (e.g., to tell a story about the event) or experience another user's shared volumetric experience. This tool-set of personalized vantage points allows users to share or view other volumetric experiences from their chosen perspective.

These shared vantage viewing points for a ‘real-life’ moment can be recorded or broadcasted for other users to experience. In one embodiment, this is accomplished from within the medium in which the user consumes the experience (e.g., via a client application) in their HMD or mobile view. In addition, the shared volumetric experience may be exported to reach other users though social media 2460 or recording and saved to walk-through the curated vantage points again at another time.

E. Share Reactions within Volumetric Space

Prior to exporting user curated virtual camera vantage points, a user can also enhance the volumetric content experience. This adds an element of personalization in the chosen vantage point.

For example, in one embodiment, users incorporate their own personalized reactions to a piece of volumetric content. Taking a user's location within the volumetric content and time-stamp within a sequence provides the ability to add reactions like emoticons, recorded audio, or other tools to convey a user's feeling and emotional reaction for the ‘real-world’ volumetric experience.

Example: Emoticons

A visual representation of a user's emotional reaction can be augmented into the volumetric experience at a certain time-stamp and determined location. These user controlled viewing angle enhancements allow users to share their own and see other user's emotional reactions to an experience. In one embodiment, emoticons are placed by a user in their virtual camera field of view (FOV). A user can also see the emoticons of other users in live and non-live experiences that are located and placed in a set time for a relevant vantage point.

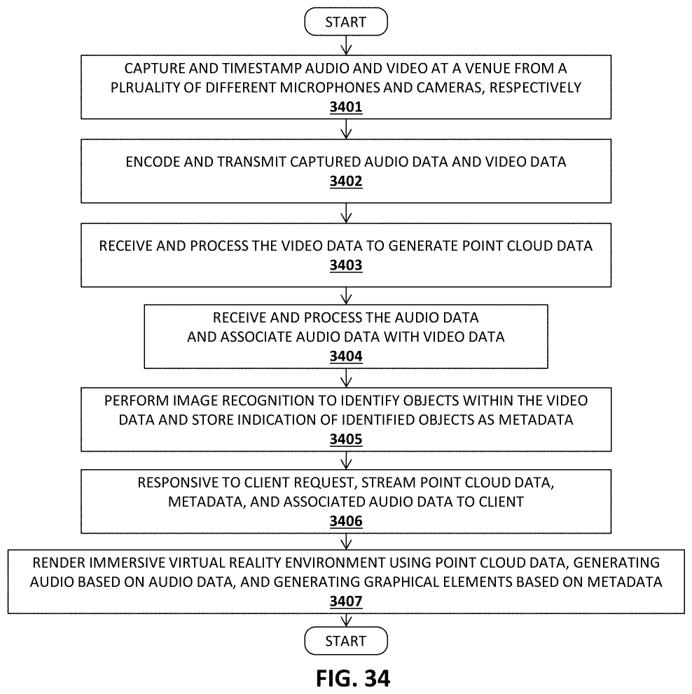

A method in accordance with one embodiment of the invention is illustrated in FIG. 34. The method may be implemented within the context of the various system architectures described above, but is not limited to any particular architecture.

At 3401, audio and video associated with a particular event at a venue is captured and timestamped. A plurality of microphones are distributed throughout the event to capture the audio and a plurality of video cameras are distributed to capture the video.

At 3402, the audio and video is encoded and streamed to a Cloud service which implements the point-cloud processing techniques described herein.

At 3403 the video data is received and processed at one or more servers on a Cloud service and at 3404, the audio data is received/processed and associated with the video data. As mentioned, processing of the video data includes generating point cloud data which can be used to render a fully immersive virtual reality environment of the event.

At 3405 image recognition is used to identify objects captured in the video. For example, the various players may be identified based on player numbers or positions and the ball may be identified based on its location on the field and movement/velocity relative to other objects. In one embodiment, machine learning is used to identify the various objects, initially training the machine learning engine to recognize the various objects. Once identified, metadata is generated to indicate the locations of the various objects.

At 3406, in response to a client request, the point cloud data, metadata, and associated audio data are streamed to a client. At 3407, the client renders a virtual reality environment using the point cloud data, generating audio based on the audio data (synchronized via the timestamps), and generates graphical elements based on the metadata (e.g., such as the various graphical tags described above). The client may superimpose the graphical elements over the rendered video as described above.

### EXAMPLES

The following are example implementations of different embodiments of the invention.

### Example 1

A method comprising: receiving video data captured from a plurality of different cameras at an event, the video data comprising a plurality of video images captured from each of the plurality of different cameras; performing image recognition on at least a portion of the video data to identify objects within the plurality of video images; associating metadata with one or more of the objects; processing the video data to generate point cloud data usable to render an immersive virtual reality (VR) environment for the event; and transmitting the point cloud data or VR data derived from the point cloud data to a client device.

### Example 2

The method of example 1 wherein the client device comprises a VR engine to render the immersive VR environment using the point cloud or VR data.

### Example 3

The method of example 2 wherein the client device is to interpret the metadata to identify objects within the VR environment and to render graphical elements and superimpose the graphical elements on or around the objects within the VR environment.

### Example 4

The method of example 3 further comprising: receiving audio data captured from a plurality of microphones at the event; and associating the audio data with portions of the video data based on timestamp values associated with the portions of the video data and portions of the audio data.

### Example 5

The method of example 4 further comprising: generating audio of the event on the client device, the audio synchronized with the immersive VR environment.

### Example 6

The method of example 1 wherein the image recognition is performed by a machine learning engine trained to identify one or more of the objects.

### Example 7

The method of example 1 further comprising: determining a location and orientation of a plurality of virtual cameras; and transmitting an indication of the virtual cameras to the client device, the indication usable by the client device to render the immersive VR environment from the perspective of one of the virtual cameras selected by an end user.

### Example 8

A system comprising: a video decoder to decode video data captured from a plurality of different cameras at an event to generate decoded video, the decoded video comprising a plurality of video images captured from each of the plurality of different cameras; image recognition hardware logic to performing image recognition on at least a portion of the video to identify objects within the plurality of video images; a metadata generator to associate metadata with one or more of the objects; a point cloud data generator to generate point cloud data based on the decoded video, the point cloud data usable to render an immersive virtual reality (VR) environment for the event; and a network interface to transmit the point cloud data or VR data derived from the point cloud data to a client device.

### Example 9

The system of example 8 wherein the client device comprises a VR engine to render the immersive VR environment using the point cloud or VR data.

### Example 10

The system of example 9 wherein the client device is to interpret the metadata to identify objects within the VR environment and to render graphical elements and superimpose the graphical elements on or around the objects within the VR environment.

### Example 11

The system of example 10 further comprising: an audio processor to receive audio data captured from a plurality of microphones at the event and to associating the audio data with portions of the video data based on timestamp values associated with the portions of the video data and portions of the audio data.

### Example 12

The system of example 11 wherein the network interface is to transmit the audio data to the client device, wherein audio of the event is generated on the client device synchronized with the immersive VR environment.

### Example 13

The system of example 8 wherein the image image recognition hardware logic comprises a machine learning engine trained to identify one or more of the objects.

### Example 14

The system of example 1 further comprising: video reconstruction hardware logic to determine a location and orientation of a plurality of virtual cameras, the network interface to transmit an indication of the virtual cameras to the client device, the indication usable by the client device to render the immersive VR environment from the perspective of one of the virtual cameras selected by an end user.

### Example 15

A machine-readable medium having program code stored thereon which, when executed by a machine, causes the machine to perform the operations of: receiving video data captured from a plurality of different cameras at an event, the video data comprising a plurality of video images captured from each of the plurality of different cameras; performing image recognition on at least a portion of the video data to identify objects within the plurality of video images; associating metadata with one or more of the objects; processing the video data to generate point cloud data usable to render an immersive virtual reality (VR) environment for the event; and transmitting the point cloud data or VR data derived from the point cloud data to a client device.

### Example 16

The machine-readable medium of example 15 wherein the client device comprises a VR engine to render the immersive VR environment using the point cloud or VR data.

### Example 17

The machine-readable medium of example 16 wherein the client device is to interpret the metadata to identify objects within the VR environment and to render graphical elements and superimpose the graphical elements on or around the objects within the VR environment.

### Example 18

The machine-readable medium of example 17 further comprising program code to cause the machine to perform the operations of: receiving audio data captured from a plurality of microphones at the event; and associating the audio data with portions of the video data based on timestamp values associated with the portions of the video data and portions of the audio data.

### Example 19

The machine-readable medium of example 18 further comprising program code to cause the machine to perform the operations of: generating audio of the event on the client device, the audio synchronized with the immersive VR environment.

### Example 20

The machine-readable medium of example 15 wherein the image recognition is performed by a machine learning engine trained to identify one or more of the objects.

### Example 21

The machine-readable medium of example 15 further comprising program code to cause the machine to perform the operations of: determining a location and orientation of a plurality of virtual cameras; and transmitting an indication of the virtual cameras to the client device, the indication usable by the client device to render the immersive VR environment from the perspective of one of the virtual cameras selected by an end user.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

We claim:

1. A method comprising:
receiving video data captured from a plurality of different cameras at an event, the video data comprising a plurality of video images captured from each of the plurality of different cameras;
performing image recognition on at least a portion of the video data to identify objects within the plurality of video images;
associating metadata with one or more of the objects;
processing the video data to generate point cloud data usable to render an immersive virtual reality (VR) environment for the event; and
transmitting the point cloud data or VR data derived from the point cloud data to a client device.

2. The method of claim 1 wherein the client device comprises a VR engine to render the immersive VR environment using the point cloud or VR data.

3. The method of claim 2 wherein the client device is to interpret the metadata to identify objects within the VR environment and to render graphical elements and superimpose the graphical elements on or around the objects within the VR environment.

4. The method of claim 3 further comprising:
receiving audio data captured from a plurality of microphones at the event; and
associating the audio data with portions of the video data based on timestamp values associated with the portions of the video data and portions of the audio data.

5. The method of claim 4 further comprising:
generating audio of the event on the client device, the audio synchronized with the immersive VR environment.

6. The method of claim 1 wherein the image recognition is performed by a machine learning engine trained to identify one or more of the objects.

7. The method of claim 1 further comprising:
determining a location and orientation of a plurality of virtual cameras; and
transmitting an indication of the virtual cameras to the client device, the indication usable by the client device to render the immersive VR environment from the perspective of one of the virtual cameras selected by an end user.

8. A system comprising:
a video decoder to decode video data captured from a plurality of different cameras at an event to generate decoded video, the decoded video comprising a plurality of video images captured from each of the plurality of different cameras;
image image recognition hardware logic to performing image recognition on at least a portion of the video to identify objects within the plurality of video images;
a metadata generator to associate metadata with one or more of the objects;
a point cloud data generator to generate point cloud data based on the decoded video, the point cloud data usable to render an immersive virtual reality (VR) environment for the event; and
a network interface to transmit the point cloud data or VR data derived from the point cloud data to a client device.

9. The system of claim 8 wherein the client device comprises a VR engine to render the immersive VR environment using the point cloud or VR data.

10. The system of claim 9 wherein the client device is to interpret the metadata to identify objects within the VR environment and to render graphical elements and superimpose the graphical elements on or around the objects within the VR environment.

11. The system of claim 10 further comprising:
an audio processor to receive audio data captured from a plurality of microphones at the event and to associating the audio data with portions of the video data based on timestamp values associated with the portions of the video data and portions of the audio data.

12. The system of claim 11 wherein the network interface is to transmit the audio data to the client device, wherein audio of the event is generated on the client device synchronized with the immersive VR environment.

13. The system of claim 8 wherein the image image recognition hardware logic comprises a machine learning engine trained to identify one or more of the objects.

14. The system of claim 1 further comprising:
video reconstruction hardware logic to determine a location and orientation of a plurality of virtual cameras,
the network interface to transmit an indication of the virtual cameras to the client device, the indication usable by the client device to render the immersive VR environment from the perspective of one of the virtual cameras selected by an end user.

15. A machine-readable medium having program code stored thereon which, when executed by a machine, causes the machine to perform the operations of:
receiving video data captured from a plurality of different cameras at an event, the video data comprising a plurality of video images captured from each of the plurality of different cameras;
performing image recognition on at least a portion of the video data to identify objects within the plurality of video images;
associating metadata with one or more of the objects;
processing the video data to generate point cloud data usable to render an immersive virtual reality (VR) environment for the event; and
transmitting the point cloud data or VR data derived from the point cloud data to a client device.

16. The machine-readable medium of claim 15 wherein the client device comprises a VR engine to render the immersive VR environment using the point cloud or VR data.

17. The machine-readable medium of claim 16 wherein the client device is to interpret the metadata to identify objects within the VR environment and to render graphical elements and superimpose the graphical elements on or around the objects within the VR environment.

18. The machine-readable medium of claim 17 further comprising program code to cause the machine to perform the operations of:
receiving audio data captured from a plurality of microphones at the event; and
associating the audio data with portions of the video data based on timestamp values associated with the portions of the video data and portions of the audio data.

19. The machine-readable medium of claim 18 further comprising program code to cause the machine to perform the operations of:
generating audio of the event on the client device, the audio synchronized with the immersive VR environment.

20. The machine-readable medium of claim 15 wherein the image recognition is performed by a machine learning engine trained to identify one or more of the objects.

21. The machine-readable medium of claim 15 further comprising program code to cause the machine to perform the operations of:
determining a location and orientation of a plurality of virtual cameras; and
transmitting an indication of the virtual cameras to the client device, the indication usable by the client device to render the immersive VR environment from the perspective of one of the virtual cameras selected by an end user.
